(19) United States
(12) Patent Application Publication
(10) Pub. No.: US 2006/0031938 A1
(43) Pub. Date: Feb. 9, 2006

(54) Integrated emergency response system in information infrastructure and operating method therefor

(76) Inventor: Unho Choi, Seoul (JP)

Correspondence Address: HARNESS, DICKEY & PIERCE, P.L.C., P.O. BOX 828, BLOOMFIELD HILLS, MI, 48303, US

(21) Appl. No.: 10/532,434

(22) PCT Filed: Oct. 21, 2003
(86) PCT No.: PCT/KR03/02210

§ 371 Date: Apr. 22, 2005

(30) Foreign Application Priority Data
Oct. 22, 2002 (KR) 10-2002-0064702

(51) Int. Cl. G06F 11/00; G06F 11/22; G06F 11/30; G06F 11/32; G06F 11/34; G06F 11/36; G06F 12/14; G06F 12/16; G06F 15/18; G08B 23/00

(52) U.S. Cl. 726/25

(57) ABSTRACT

The present invention relates to an emergency response system for use in a whole-national or whole-enterprise information infrastructure including computer systems, networks, application programs, the internet and an operation method thereof. The emergency response system automatically collects/classifies various infringements (hacking, computer virus, worm virus, cyber-terror, network spy etc), processes/analyzes information on the infringements in necessary manner according to the corresponding organization, and uses processed or analyzed information. Furthermore, the emergency response system provides a trusted information sharing system and a communication network for sharing accumulated information as above, provides an infringement evaluation and early warning for the infringements, and performs a simulation for possible infringements.

### FIELD OF THE INVENTION

The present invention relates to an integrated computer emergency response system for use in an information technology infrastructure and an operating method therefor, and more particularly to an integrated computer emergency response system capable of automatically collecting/classifying information about a wide range of security incidents (such as hackings, worms, cyber terror, network espionage and information warfare) and vulnerability information, which may threaten an information technology infrastructure, accumulating/analyzing the information through a method proper for an involved organization; safely sharing or providing information for the protection of accumulated information and technology; performing an attack assessment for each security incident; creating an early warning for any security incident; and performing a test (simulation) for a new incident or an attacking method, thereby efficiently responding to any security incident; and a method for operating said system.

### DESCRIPTION OF THE PRIOR ART

With the deeper penetration and spread of the internet, the use of internet banking services and e-commerce is being rapidly increasing. Companies, governments and banks tend to offer on-line services and marketing through internet shopping malls or homepages.

Under these circumstances, illegal acquisitions of personal information, credit/finance information and information about a company's (public Org./R&D institute) marketing strategy or new product development, and unauthorized access causing internet service interruption or disruption are increasing. Thus, various information security systems, such as firewall (F/W) systems, intrusion detection systems (IDS) and anti-virus product, are used to prevent illegal or unauthorized activities (for example, hackings or worm/virus attacks targeting unspecified persons) and thereby protect computer systems. However, such information security systems are independently operated by company/public Org./R&D institute etc., without sharing patches or methods of responding to security incidents as mentioned above.

Also, it happens frequently that an insider who has been bribed or an outside hacker accesses a company(public Org./R&D institute etc.)'s system and illegally releases the company(public Org./R&D institute etc.)'s confidential information about members, new product information or financial transactions by selling diskettes, hard discs or CD ROMs storing confidential information.

In general, inside information about a company(public Org./R&D institute etc.) is available only within the company(public Org./R&D institute etc.) when needed for the company(public Org./R&D institute etc.) management. Most companies prevent their inside information from being released outside, unless the information contributes to the improvement of the company(public Org./R&D institute etc.)'s image or improves publicity. Recently, however, a rash of hackings of information about companies' new products, services or marketing strategies in order to sell the information to companies' competitors, internet service interruption or disruption in order to damage companies' images and reputations, homepage hackings, and malignant virus or worm outbreaks have greatly increased. Nevertheless, most companies do not have sufficient human resources capable of responding to such security incidents, information security products or information security organizations for financial reasons.

Therefore, it is necessary to establish and operate an enterprise-level or nationwide integrated computer emergency response system (ESM: Enterprise Security Management System) for effectively responding to security incidents with a few computer security experts.

FIG. 1 is a diagram showing the structure of a general internet service system.

As shown in FIG. 1, a general internet service system comprises a user computer 110, an internet 120, an ISP 122, a router 124, a switching hub (126), a WAP server 140, a web server 150, a mail server 160, an information sharing server 170 and a database server 180.

To be specific, the general internet service system includes: the router 124 for optimizing a path for providing any requested information when more than one user physically accesses the internet 120 using the user computer 110 and requests financial information for the purpose of subscription or purchase; the switching hub 126 for interpreting received packet data and selecting a final destination to send the data to improve the information transmission speed; the web server 150 for displaying a web page of information selected by more than one user while physically being connected to the web browser of the user computer 110; the information sharing server 170 for supporting information shared between users through information exchanges on the selected information web page; the database server 180 for storing information about the users and an agreement therebetween; the mail server 160 for automatically sending information about an agreement between the users and the results of the agreement via an e-mail; a WAP (Wireless Application Protocol) gateway 130 for converting a protocol of data transferred through a wireless communication network into an information transfer protocol on the internet 120 when the users request information through a mobile terminal; and the WAP server 140 for receiving information-requesting data transferred through the WAP gateway 130, searching for some content stored in a content database through a CGI (Common Gateway Interface) script and displaying such detected content data on the mobile terminal.

The user computer 110 can access the internet 120 through an ISP (Internet Service Provider) 122 or a LAN. The web server 150 includes a web page calling module for providing more than one information web page to the user computer 110.

The information sharing server 170 includes: a subscription module for processing a user's membership subscription or purchase on a web page; a member section/group module for supporting the setting of a section or a group for subscribed users; an agreement processing module for receiving a request for agreement between users, sharing information between the agreed users and processing purchase information; an agreement searching module for searching for any request for agreement of more than one user; and a homepage sharing module for supporting the sharing of a homepage between the agreed users.

The database server 180 includes: a member database for storing detailed information about subscribed users; a section/group database for storing information about sections and groups of the subscribed users; an agreement database for storing results of any agreement between the users; a homepage building database selectable by the users; and a homepage database for storing data of a homepage completed according to the users' selection.

The thusly configured internet service system may connect individuals, departments and organizations. The internet service system allows the users to classify information in sections or groups according to fields of interest. Accordingly, subscribers can share information by sections or groups. Since more than one piece of information may be displayed on more than one user's terminal, users can come to an agreement for sharing information. Upon such an agreement, the users can share information through their terminals.

As stated above, the users can access the information sharing server 170 established on the internet 120 and share necessary information. However, it happens frequently that unsubscribed intruders access credit and finance information related systems and obtain personal information, credit card numbers or official PKI certificate information for internet banking to illegally use such information for ill-intentioned purposes. There is a growing need for urgent Countermeasure against such security incidents. Also, ill-intentioned users spread computer viruses or worms to commit cyber terror or computer crimes, such as those as prescribed in the Information Infrastructure Protection Act, for the purposes of destroying critical information or paralyzing important services.

In the past, a victim of hacking or other security incidents consulted with an information security center (like a CERT), such as a CERT (Computer Emergency Response Team), over the phone or via e-mail. The information security center (like a CERT) manually inputted information about any damage, system administrator, blacklist (e.g., IP addresses) and log/patch information, history management and backup of the pertinent system. Based on such information, the information security center (like a CERT) analyzed the security incident. Thus, it generally took several days to several weeks to complete an analysis.

In certain cases, to avoid blame when security incidents occur, company(public Org./R&D institute etc.) security administrators may format and clear intrusion tracks such as logs, in a computer or restore the computer system for rapid resumption of services, without retaining any event logs. Even if the security incidents are reported to a CERT, a cyber crime investigator or the National Intelligence Service at a later time, it will be difficult to track a criminal due to a lack of convincing evidence. Also, since no reliable network for sharing information is established between systems of the related company/public Org./R&D institute etc., e.g., between a CERT system and a cyber crime investigator system, it is difficult to establish an automatic and comprehensive mutual-assistance system for effectively responding to security incidents.

Recently, individuals or companies may obtain, via e-mail from domestic or foreign CERTs, hardware vendors such as IBM and SUN, and operating system vendors such as Microsoft, information about system or network elements, recognized as being vulnerable to encounter threatening incidents, and store the vulnerability information in order to respond to possible security incidents. However, e-mails regarding the vulnerability information are too numerous for a system or network administrator to store and manage them. Also, when a vulnerability-exploiting incident occurs, it is difficult to rapidly and properly respond to the incident. Although some paid or free services are available, a system administrator of each organization will have trouble in filtering information about necessary systems and responding to security threats and vulnerabilities.

Also, it is difficult to apply security patches for operating systems which have the same vulnerability but fall into different categories with different contents or formats.

System administrators can identify vulnerabilities existing in currently operating systems by accessing a homepage of a CERT, a hardware provider or an operation system provider and manually apply security patches for those systems. However, they have to check the vulnerabilities at night after stopping services or on holidays. Also, a company(public Org./R&D institute etc.) or an each Org./company etc. having a few computer security experts may have difficulty in thoroughly checking large data of newly reported security vulnerabilities on a daily basis. A failure to completely prevent the generation of any security vulnerability frequently results in serious security problems, such as system hacking or service interruption.

It is still difficult for system administrators to know exactly the vulnerabilities and history of their systems, apply security patches everyday and effectively respond to any security issues, attacks or other critical incidents reported by an intrusion detection system. Actually, system administrators cannot cope with the frequent spread of malignant computer viruses or worms in sufficient time.

Although there is a growing need to protect critical information systems, computer centers or systems of companies and other finance or telecommunication related CIP (Critical Infrastructure Protection) systems as prescribed in the National Information Infrastructure Protection Act (Law No. 6383, A Korea) or US, Department of Homeland Security (DHS) (http://www.dhs.gov/dhspublic/) defined from hackings or cyber terror, no efficient or comprehensive solution has not yet been suggested.

As countermeasure against security incidents, ESM (Enterprise Security Management) or MSS (Managed Security Systems) software solutions have been developed. An initially-developed first-step ESM is a “management tool” that analyzes and monitors various security threats that may affect critical network or system resources. The first-step ESM incorporates multi-vendor information security solutions, such as a firewall (F/W) system, an intrusion detection system (IDS) and an anti-virus solution to provide a method for monitoring threats on a single monitor screen. However, the first-step ESM is primitive and inconvenient when a security administrator wishes to correlate and respond to diverse security incidents even after filtering the incidents by a fixed method. For more effective application of such an ESM, many security experts who can analyze security incidents are needed. Actually, most companies and organizations do not use such an ESM for a lack of sufficient security experts.

A second-step ESM is a tool for analyzing the linkage and correlation of security information (events or incidents), announce the analysis results and responding to the security incidents. However, because of an enormous amount of data to be analyzed and a lack of sufficient analysis bases, this ESM is not capable of an immediate computer emergency response, an attack assessment or an early warning for critical security incidents.

A third-step ESM has not yet been commercially available. The goals of development of this ESM are to analyze correlation between security information through data mining or the like, establish a security incident analysis system and reinforce security functions. However, the solutions required by each purchaser are only partially realized in this ESM.

Therefore, a more effective and comprehensive computer emergency response system and a method for operation thereof are needed.

FIG. 2 shows an example of a computer emergency response system (ESM) in the prior art. An ESM 210 comprises: an agent/security product group 212 including an intrusion detection system (IDS), a firewall (F/W) system, a virtual private network (VPN), a anti-virus product and information Secure OS etc.; an ESM security system 213 including an IDS and an F/W etc. to protect information of the ESM itself; an access control section 214 including a card door (for example, a door with an RF card system), a biometrics system for recognizing fingerprints, iris patterns, palm prints or weights and a CCTV etc.; and an ESM management system 211 for controlling each ESM element. The ESM detects security incidents occurring in various systems of companies or organizations and stores the incidents in a database.

The ESM management system 211 serves as a monitoring system that collects and monitors information about diverse incidents occurring in the agent/security product groups 213. When information collected by each product in the agent/security product group 213 is transferred to the monitoring system, the system divides a window on its monitor into four, six or other required number of sections to display all the collected information at a time.

In the prior art, ESM cannot comprehensively respond to security incidents because it is separated into different information security systems. Also, ESM generates too much information relating to each security product to completely analyze and handle it. ESM is less effective in determining the severity of a security incident or detecting any incident before occurrence.

It was expected that the third-step ESM would have an improved responsiveness with respect to security incidents. However, even the third-step ESM fails to comprehensively respond to security incidents with enhanced functions, such as early warning for security incidents, utilization of a computer forensic DB, incident history management, asset evaluation and recovery period calculation, and by safe information sharing with an external ISAC system or another ESM center.

With the explosive increase in the use of internet, events and logs with tens of mega bytes to tens of giga bytes of data are presented every day with respect to ESMs and related security subsystems, according to security policies. Under the current circumstances, it is almost impossible for one or two administrators to exactly respond to such incidents. Studies are under progress to discover a method of selecting and removing extremely dangerous threats and attacks among such incidents. However, such a method will not be effective in actual application. Although a highly dangerous attack is reported by an alert alarm immediately when it occurs, investigation is made manually on the previous information security, incident history, etc., of the attacked system. Thus, it is often the case that a remedy is sought only after damages result from an attack.

With a growing concern about critical information security and ESM, governments in advanced countries, including the U.S. and many in Europe, directly handle security issues. The U.S., in particular, operates as many as 17 ISACs (Information Sharing and Analysis Centers) between multiple ESMs and CERT systems to protect important information and communication infrastructures. The technical knowledge and know-how for operating the ISACs are kept secret as national secrets. Article 16 of the Korean Information Infrastructure Protection Act prescribes the necessity of ISACs for financial, communication or other information technology infrastructures. Civil information security companies are also focusing on the development of technology and human resources to establish an integrated computer emergency response system (ESM: Enterprise Security Management System) that combines ESM and ISAC models and implements management of events and logs as done by conventional simple information security products, such as intrusion detection systems and anti-virus solutions. However, most security companies face financial difficulties and lack of sufficient technical experts.

According to a report on the current information security situations, researches are conducted based on the following four situations:
1) Organizations have insiders' or outsiders' cyber attacks;
2) A wide range of cyber attacks are detected;
3) Cyber attacks result in serious financial losses; and
4) A successful defense often requires more than the use of information security technology.

In order to cope with such situations, it is necessary to establish ESMs for collaboration between company/public Org./R&D institute etc., groups or companies in the same field or industry which are vulnerable to similar cyber terror or hackings, CERTs (Computer Emergency Response Teams) for fast response to computer emergencies, such as hackings, worms, viruses and cyber terror, and ISACs for integrated management of multiple ESMs and CERTs. It has been planned to build security centers for each infrastructure as prescribed under the Act in order to realize the establishment and operation of the ESMs, CERTs and ISACs. However, such security centers are being built separately and independently because no utilized technical model is available.

### SUMMARY OF THE INVENTION

The present invention has been made in the abovementioned views and relates to a method for establishing an enterprise-level integrated computer emergency response system (or ESM: Enterprise Security Management System) in a form of an ISAC (Information Sharing and Analysis Center/System). When the integrated computer emergency response system is linked with another ISAC or an ESM (Enterprise Security Management) system, a trusted information sharing network can be established between ISACs, ESMs, or an ISAC and multi-ESMs to share information for coping with hackings or cyber terror.

More specifically, the present invention relates to a method for establishing an enterprise-level integrated computer emergency response system (ESM: Enterprise Security Management System) in form of an ISAC for sharing vulnerability information relating to personal or civil IT information and a company(public Org./R&D institute etc.)'s information security at a remote place and comprehensively responding to security incidents, including unauthorized access such as hackings, virus spreads, cyber terror, and a trusted information sharing network for sharing information between the integrated computer emergency response system and another ISAC or ESM.

Therefore, the present invention has been made in view of the above-mentioned problems, and it is an object of the present invention to provide an integrated computer emergency response system which can collect security information about nationwide or enterprise-wide systems or networks, applications and internet services, interworking with systems of various company/public Org./R&D institute etc.; process and analyze the collected information to manage it as a database; provide processed and analyzed information to a relevant each Org./company etc.'s system if required; issue early warnings when system attacks are anticipated; and protect its own information through certain means; and a method for operating the integrated computer emergency response system.

Another object of the present invention is to provide an integrated computer emergency response system which can perform a simulation using a test-bed of a new security incident under the same condition of a system to be protected, store the simulation results in a database, evaluate an asset of the system to be protected and calculate damage and a recovery period based on the estimated asset, and which enables a victim of an actual computer incident to seek a monetary compensation by filing a complaint or a suit based on past attack log records stored in a computer forensic manner.

Still another object of the present invention is to provide an integrated computer emergency response system having an CERT/ISAC/ESM to CERT/ISAC/ESM interworking section for interworking with security Center/ESM/ISAC systems of other company/public Org./R&D institute etc. to share reliable system security information.

These objects can be realized by both proper hardware and proper software. Also, all the processes mentioned above are automatically implemented.

According to one aspect of the present invention, there is provided an integrated computer emergency response system comprising: an information collecting/managing section for collecting security information about a wide range of security incidents and vulnerabilities which may be a threat to systems to be protected, via nationwide or enterprise-wide information technology infrastructures, including computer systems or networks, applications and internet services, and storing source data; an information processing/analyzing section for processing and analyzing collected security information using a predetermined analysis algorithm and storing and managing analysis results; an operating system section including an information sharing/searching/announce unit for transferring the processed and analyzed information to at least one system to be protected or an external system and a display unit for outputting necessary security information in a predetermined form; an information security section for protecting the integrated computer emergency response system's own information; and a database section including a vulnerability DB for storing vulnerability information and a source/processed DB for storing source data and processed data.

In the integrated computer emergency response system, the information collecting/managing section includes: a vulnerability DB collecting unit for collecting, classifying and processing vulnerabilities officially recognized and provided by various domestic or foreign company/public Org./R&D institute etc., system hardware vendors and OS (operating system) vendors; an incident report collecting unit for receiving security incident reports through communication means, such as telephone, facsimile, e-mail and web sites, and storing information about reported incidents; an information security data collecting unit for collecting and storing information security data or references published by CERTs or ISACs, colleges, research centers and government company/public Org./R&D institute etc. with respect to security incidents, including hackings, and countermeasure against the incidents, using an automated collecting tool, such as a web robot or a search engine; a Virus/Worm Information collecting unit for collecting and storing information about computer viruses or worms using an automated collecting tool, such as a virus alert system, an agent or a search engine; an incident report collecting unit for receiving security incident reports through communication means, such as telephone, facsimile, e-mail and web sites, and storing information about reported incidents; a system asset information collecting unit for collecting and normalizing information about systems and network devices involved in the integrated computer emergency response system and asset information relating to the significance (asset values) of the systems and the network devices and storing the collected information; and an event collecting unit for collecting and storing in real time events relating to information security from at least one information security product of a firewall (F/W) system, an intrusion detection system (IDS), a policy management system, a anti-virus product, a PC information security system, a retracing system, a PKI certification system, a network device and a virtual private network (VPN).

Further in the integrated computer emergency response system, the information processing/analyzing section includes: a dataware housing unit for normalizing information collected by the information collecting/managing section in various categories and establishing a database storing information; and an information analyzing unit for analyzing the information stored in the database established by the dataware housing section by applying a data mining or knowledge-based analysis algorithm and an analysis algorithm for analyzing security incidents and vulnerabilities, correlations with major assets, recognizable patterns and classifications for preventing incidents and vulnerabilities.

Further in the integrated computer emergency response system, the system further comprises: an attack assessment section for performing attack assessments for security incidents, such as hackings or cyber terror, classifying the incidents based on past attack methods and frequencies, supplying possible attack scenarios and automatically implementing attack assessment functions, including databasing of vulnerability analysis results, real-time analysis of critical attacks, collection and analysis of important packets and issuance and spread of a forecast/warning, in a pre-defined manner; and a test-bed for supplying a possible scenario when a new security incident or vulnerability is detected and performing a simulation under the same condition of a system to be protected so that an attack level and any damage and effective response can be expected.

Further in the integrated computer emergency response system, the system further comprises an early forecast/warning section for generating an alert signal to the results issued by the test-bed or attack assessment section and sending the alert signal to a system to be protected or an external system to inform of any security incident or vulnerability.

Further in the integrated computer emergency response system, the system further comprises an asset evaluation/recovery period calculation section for evaluating the significance or asset value of a system to be protected and anticipating damage resulting from a possible security incident and a recovery period based on the evaluated significance of the system.

Further in the integrated computer emergency response system, the system further comprises an automatic education/training section for generating educational information from the results of a simulation performed at the test-bed, storing and managing the educational information and sending the educational information to an external terminal that requires education.

Further in the integrated computer emergency response system, the system includes: a physical information security unit including at least one of a card certification unit, a password certification unit, a biometrics unit and a CCTV; and a network/system/document security unit including at least one of a PKI certification system, an intrusion detection system, an anti-virus system, a retracing system and a watermarking system.

Further in the integrated computer emergency response system, the system includes: an information management unit for processing, analyzing and taking statistics on information to be exchanged with external systems in an encrypted standard format and classifying company/public Org./R&D institute etc. according to user classes; and an interface for performing an access control (providing data according to user classes) and a protocol conversion for data exchange with external systems.

According to another aspect of the present invention, there is provided a method for responding to a security incident by using an integrated computer emergency response system, which comprises: an information collecting step performed by an information collecting/managing section to collect security information about security incidents and vulnerabilities through a predetermined communication network; an information processing/analyzing step performed by an information processing/analyzing section to database collected security information and analyze the databased information using a predetermined analysis algorithm; an information sharing/searching/announce step of managing processed and analyzed security information to be shared and searching for and providing the information upon request; and an alerting step of sending predetermined early warning information to at least one of any inside and outside systems if an alert is required for any incident or vulnerability.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram showing the structure a general internet subscription and purchase system using finance and credit information;

FIG. 2 is a block diagram of a conventional enterprise security management (ESM) system;

FIG. 3 is a block diagram briefly showing the structure of an integrated computer emergency response system according to the present invention;

FIG. 4 shows operations of an integrated computer emergency response system according to the present invention;

FIG. 5 shows the detailed structure of an information collecting/managing section according to the present invention;

FIG. 6 is a view for explaining the functions of a vulnerability DB collecting section, an information security data collecting section and a virus/worm information collecting section of the information collecting/managing section;

FIG. 7 is a view for explaining the functions of a vulnerability scanning result collecting section of the information collecting/managing section;

FIG. 8 is a block diagram showing the automated vulnerability collection performed by the vulnerability DB collecting section, information security data collecting section and virus/worm information collecting section using a web robot;

FIG. 9 is a view for explaining the functions of an incident report collecting section of the information collecting/managing section;

FIG. 10 is a view for explaining the functions of an asset information collecting section for collecting asset information of systems;

FIG. 11 is a block diagram showing the functions of an information security product event collecting section of the information collecting/managing section;

FIG. 12 is a block diagram showing the detailed structure of an information processing/analyzing section of the integrated computer emergency response system according to the present invention;

FIG. 13 is a block diagram showing a process of establishing a dataware housing section in the information processing/analyzing section;

FIGS. 14 and 15 show the functions of an information sharing/searching/announce section included in an operating system. The profile management function is shown in FIG. 14, while the information search and spread functions are shown in FIG. 15;

FIG. 16 shows the detailed structure of a system information security section for protecting the integrated computer emergency response system's own information;

FIG. 17 is a block diagram of an CERT/ISAC/ESM to CERT/ISAC/ESM interworking section for interworking with external systems to share reliable security information;

FIG. 18 shows the detailed structure of a vulnerability DB 6100 used in the present invention;

FIG. 19 is a block diagram showing information protecting and alerting mechanisms using the integrated computer emergency response system according to the present invention;

FIG. 20 shows the function of an attack assessment section according to the present invention;

FIG. 21 is a view for explaining the establishment of a computer forensic DB according to the present invention;

FIG. 22 is a block diagram showing a process of asset evaluation and recovery period calculation according to the present invention; and

FIG. 23 is a block diagram showing the establishment of the blacklist DB and the history management according to the present invention.

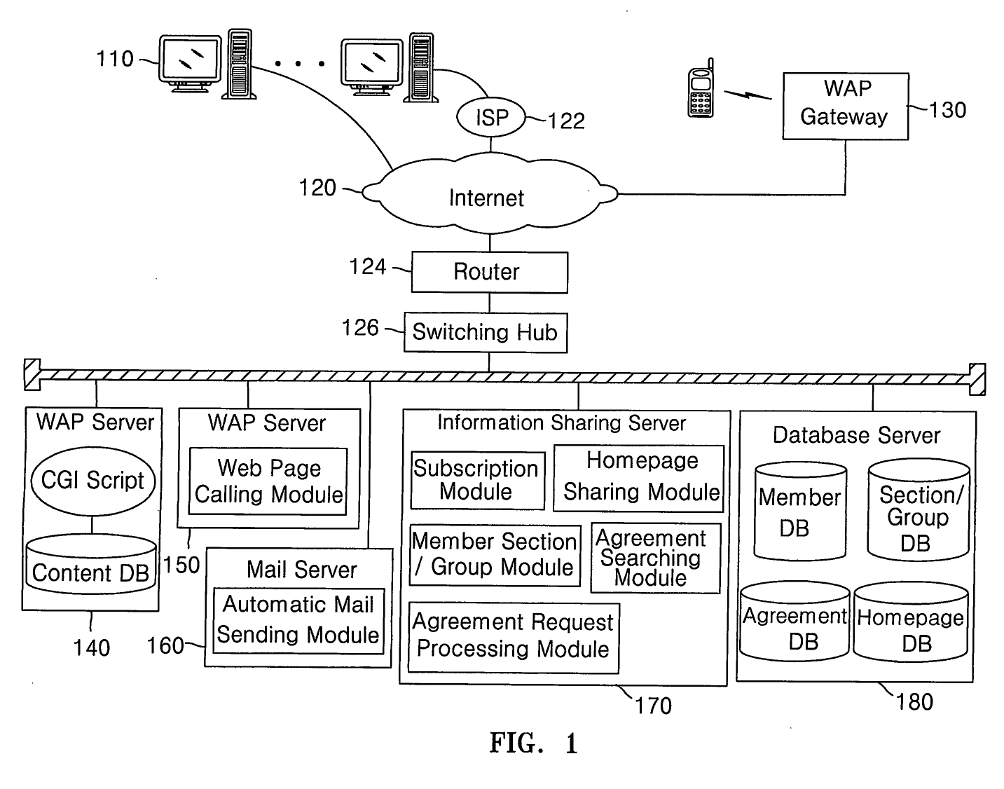

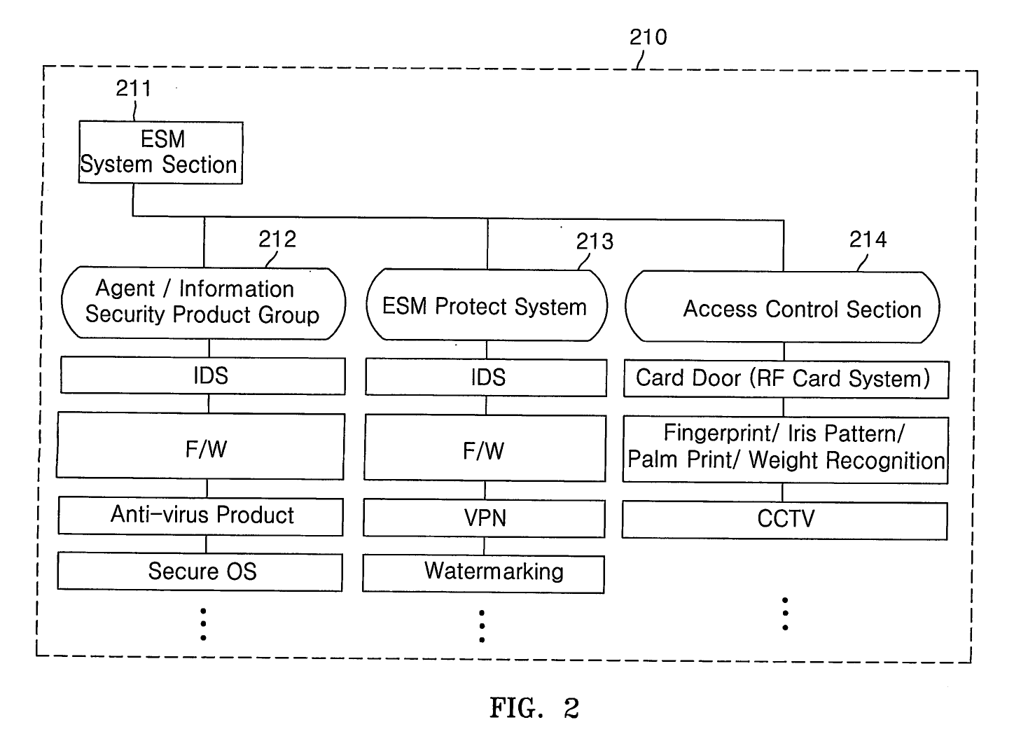

### DETAILED DESCRIPTION OF THE INVENTION

Reference will now be made in detail to the preferred embodiment of the present invention.

The term “security information” used herein refers broadly to all information needed to protect any specific critical information. The term “security” has the same meaning as information protection.

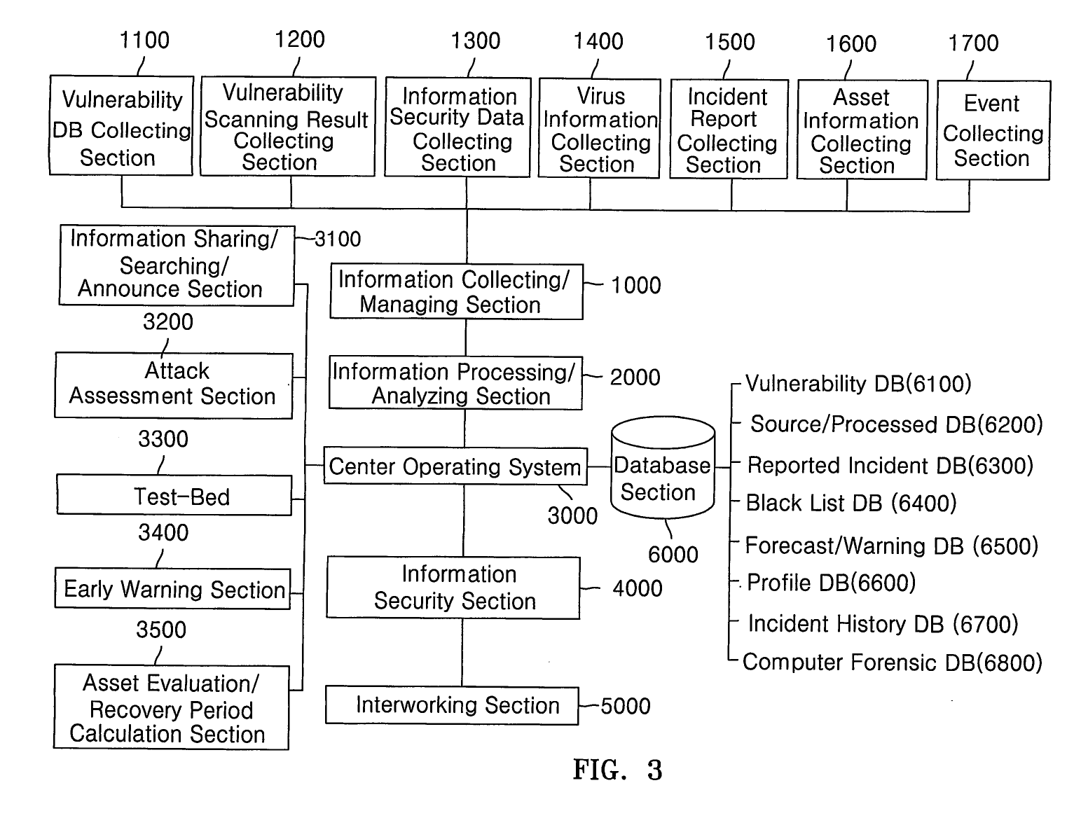

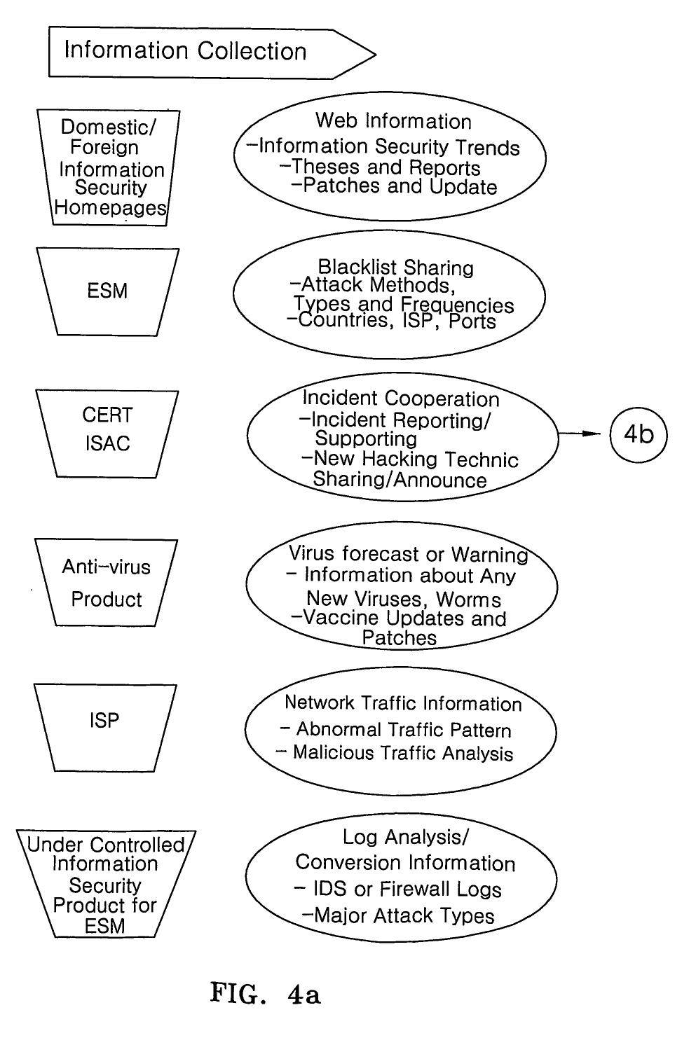

FIG. 3 is a block diagram briefly showing the structure of an integrated computer emergency response system according to the present invention.

As shown in FIG. 3, the integrated computer emergency response system comprises: an information collecting/managing section 1000 for collecting security information about computer systems or networks, applications and internet services which need to be protected, through communication networks, such as web sites, telephone, e-mail and facsimile, and storing source data; an information processing/analyzing section 2000 for processing and analyzing the collected security information using a knowledge-based analysis algorithm to store and manage the analysis results; an information sharing/searching/announce section 3100 for classifying and managing the processed and analyzed security information and transferring it to at least one system to be protected or an external system; a center operating system 3000 including a display section (a wallscreen or a plurality of monitor sets) for outputting necessary security information in a predetermined form; an information security section 4000 for protecting the integrated computer emergency response system's own information; a vulnerability database 6100 for storing vulnerability information; and an CERT/ISAC/ESM to CERT/ISAC/ESM interworking section 5000 for interworking with external systems to share reliable information.

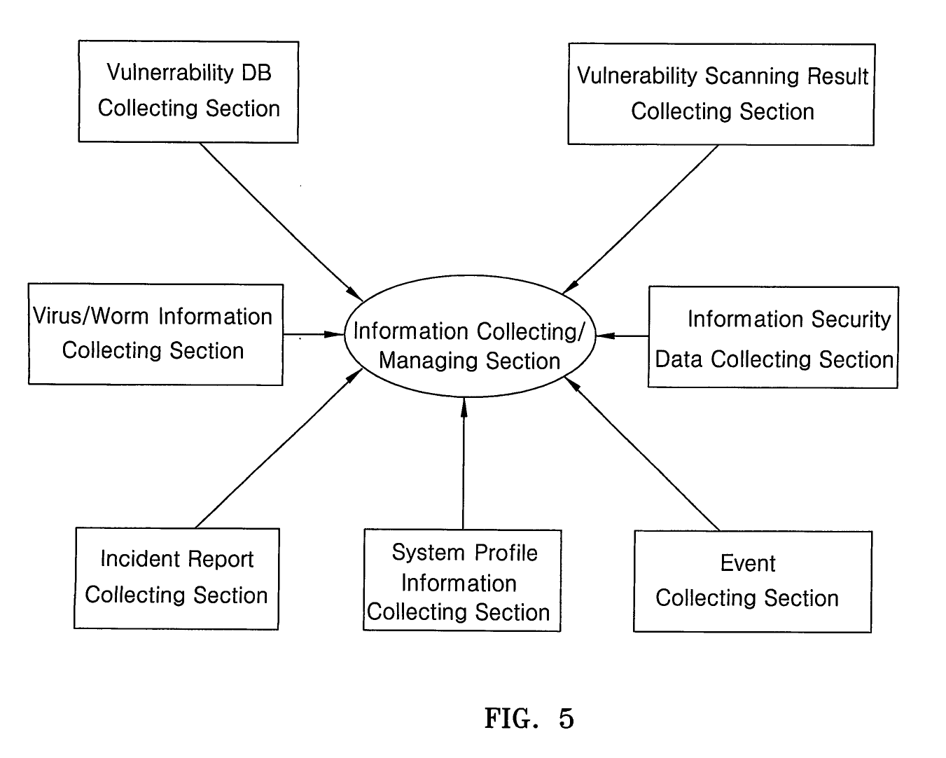

As shown in FIG. 5, the information collecting/managing section 1000 may include and is not limited to include: a vulnerability DB collecting section 1100 for collecting, classifying and processing vulnerabilities officially recognized and provided by various domestic or foreign company/public Org./R&D institute etc., system hardware vendors and OS (operating system) vendors; a vulnerability scanning result collecting section 1200 for periodically scanning vulnerabilities of systems or networks and collecting the results; an information security data collecting section 1300 for collecting and storing information security data or references published by information security companies, colleges, research centers or government company/public Org./R&D institute etc. with respect to security incidents, such as hackings and cyber terror, and countermeasure against the incidents, using an automated collecting tool, such as a web robot or a search engine; a virus/worm information collecting section 1400 for collecting and storing information about computer viruses or worms using an automated collecting tool, such as a virus alert system, an agent or a search engine; an incident report collecting section 1500 for receiving security incident reports through communication means, such as telephone, facsimile, e-mail and web sites, and storing information about reported incidents in a reported incident DB 6300; a system asset information collecting section 1600 for collecting information about systems and network devices involved in the integrated computer emergency response system and asset information relating to the significance (asset values) of the systems and the network devices and storing the collected information; and an event collecting section 1700 for collecting and storing in real time events relating to information security from at least one information security product of a firewall (F/W) system, an intrusion detection system (IDS), a policy management system, a anti-virus product, a PC information security system, a retracing system, a PKI certification system, a network device and a virtual private network (VPN).

Functions of each element of the information collecting/managing section 1000 will be explained in further detail with reference to FIGS. 5 to 11.

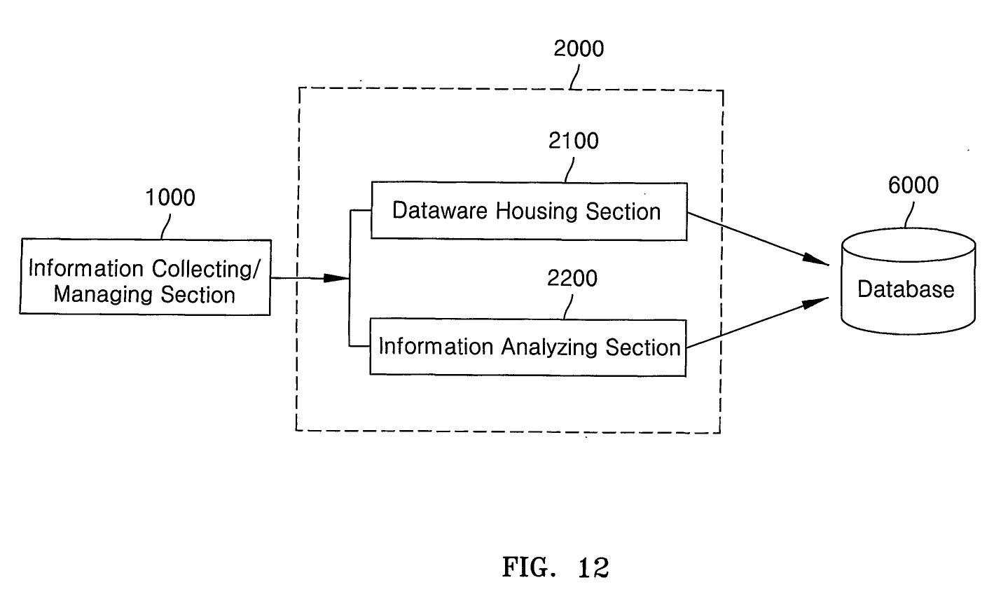

The information processing/analyzing section 2000 includes: a dataware housing section 2100 (see FIG. 12) for normalizing information collected by the information collecting/managing section 1000 in various categories and establishing a database storing the information; and an information analyzing section 2200 for analyzing the information stored in the database established by the dataware housing section 2100 by applying a data mining or knowledge-based analysis algorithm and an analysis algorithm for analyzing security incidents and vulnerabilities, correlations with major assets, recognizable patterns and classifications for preventing incidents and vulnerabilities.

The information analyzing section 2200 may have an additional function of automatically analyzing worm or virus spread paths, major distribution times, main attackers, information about systems classified as significant assets, attack types, analyzable patterns, countermeasure according to risks and positions of pre-installed sensors.

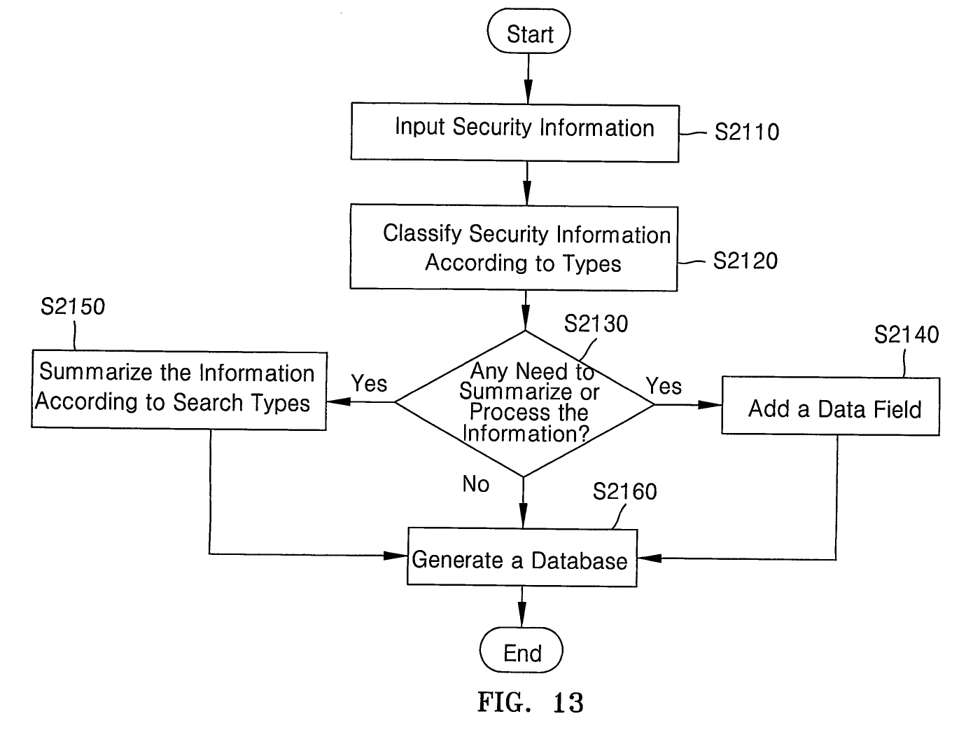

The dataware housing section and the information analyzing section will be explained in further detail with reference to FIGS. 12 and 13.

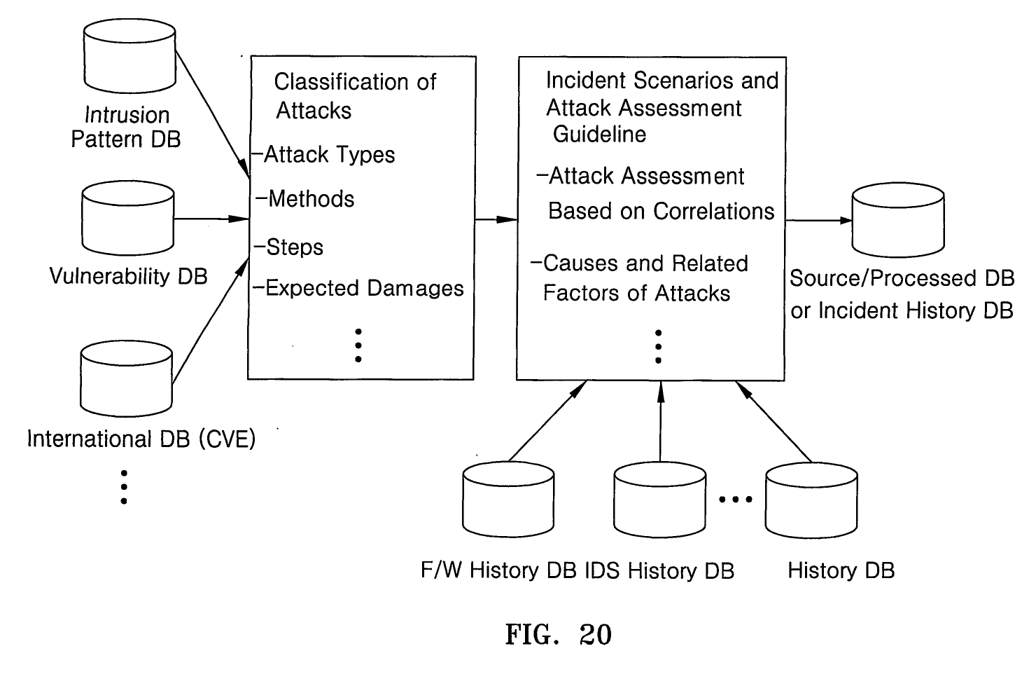

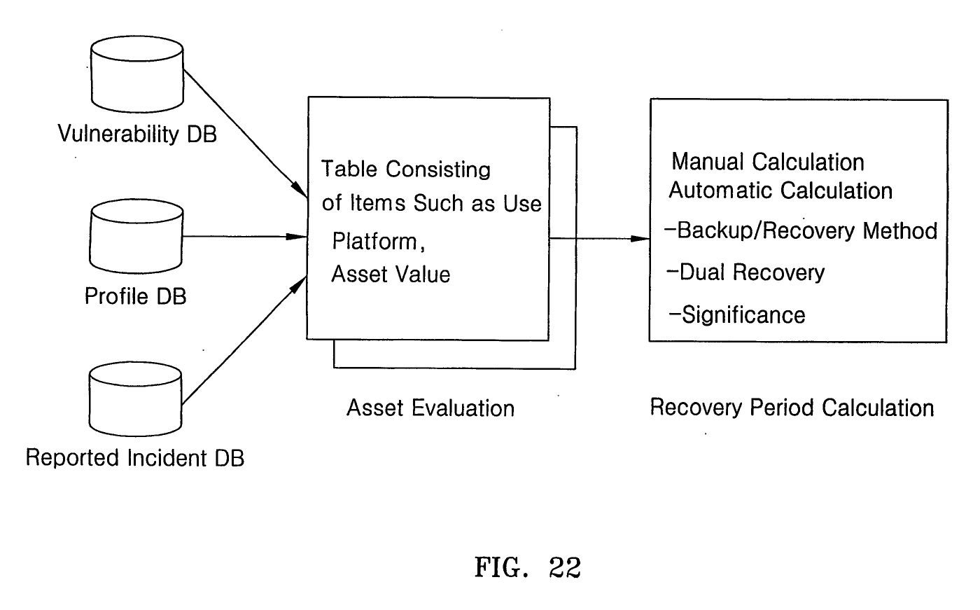

The center operating system 3000 essentially includes: the information sharing/searching/announce section 3100 for managing processed and analyzed security information and transferring it to at least one system to be protected or an external system; and the display section (a wallscreen or a plurality of monitor sets) for outputting necessary security information in a predetermined form. The center operating system 3000 may additionally include: an attack assessment section 3200 for assessing the severity level of each security incident; and/or a test-bed 3300 for performing a simulation of a new security incident under the same condition of a system sought to be protected. Also, the center operating system 3000 may additionally include: an early forecast/warning section 3400 for issuing a forecast or an alert for any security incident having occurred or possibly to occur in future in a system to be protected or an external system according to the results issued by the test-bed or attack assessment section; and/or an asset evaluation/recovery period calculation section 3500 for evaluating the significance or asset value of a system to be protected and anticipating damage resulting from a possible security incident and a recovery period based on the evaluated significance of the system. The attack assessment section and the asset evaluation/recovery period calculation section will be explained in further detail with reference to FIGS. 20 and 22.

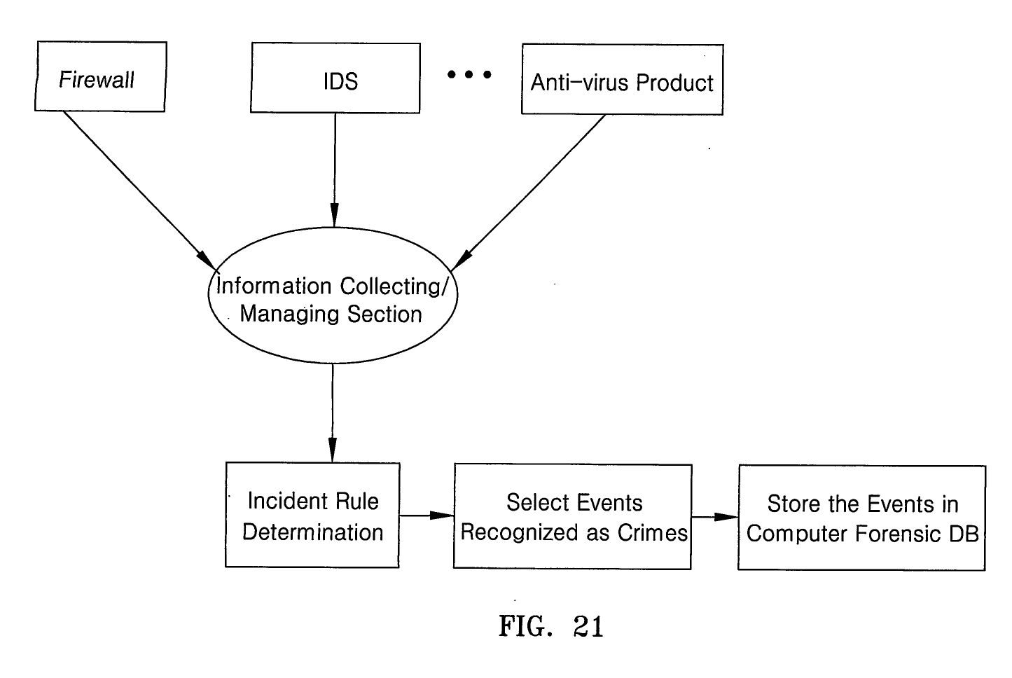

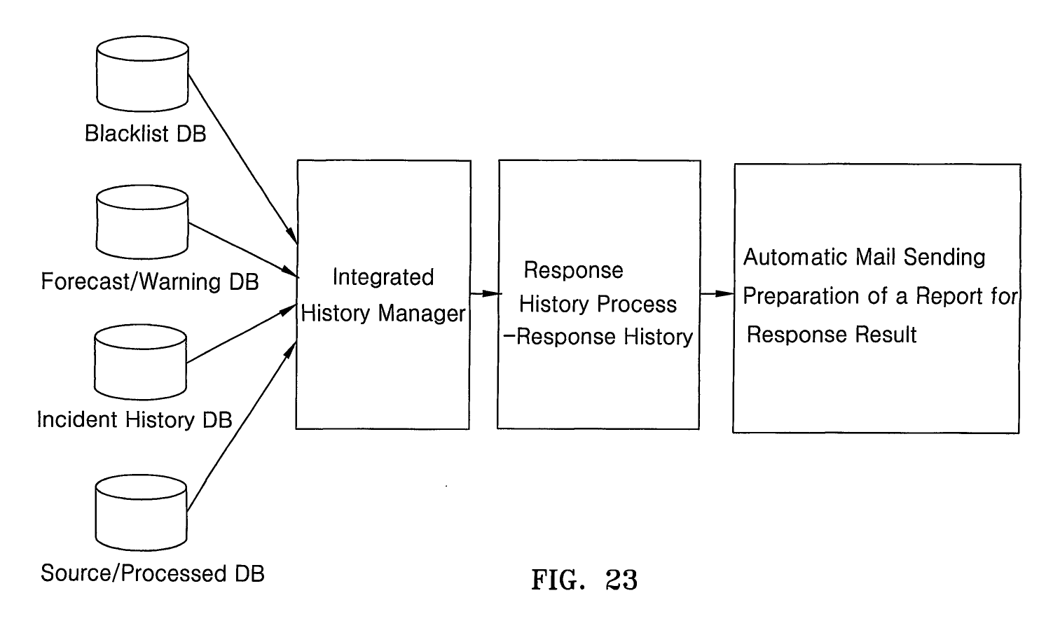

The attack assessment section 3200 assesses an attack, such as cyber terror, reported to the incident report collecting section 1500, interworking with the information processing/analyzing section 2000, and classifies the attack based on past attack methods and countermeasure. The attack assessment section 3200 supplies a possible attack scenario and produces results of a simulation performed by the test-bed. Also, the attack assessment section 3200 extracts a blacklist IP that records high-level attack methods and frequency, and manages countermeasure against such attacks (see FIG. 23). When an attack occurs, the attack assessment section 3200 automatically generates a computer forensic DB (see FIG. 21).

The early forecast/warning section 3400 is divided into a forecast system and an alert system. The forecast system implements functions, such as real-time analysis of attacks, collection and analysis of important packets, issuance and spread of a forecast, by reference to the analyzed and databased security incident information and vulnerability DB. The alert system monitors an important traffic change and an increase of pre-defined threats, collects attack information, determines steps for responding to an attack in real time, selects an alerting method and manages incidents and alert history.

The display section (a wallscreen or a plurality of monitor sets) of the center operating system 3000 displays situations of security incidents, such as cyber terror, hackings or virus/worm spreads, and response information. Specifically, the display section displays a list of vulnerabilities analyzed and databased according to the company/public Org./R&D institute etc., branches or member companies involved in the integrated computer emergency response system, real-time analyzed critical attack information, collected and analyzed important packets, information about issuance and spread of a forecast or an alert, important traffic, threats, integrated attack information, real-time determination and alert information, incident- and alert history management information, noticeable (worm) virus spread paths, time information, attackers, information to be protected, patterns, risk levels, position of sensors, and so on. The display section may output a breakdown of incident reports, results of incident responses and forecast/warning issuance information. A display section of a relevant each Org./company etc.'s system may output unsettled incident reports, new threat and forecast/warning situations (dates, vulnerability titles, status and completion of forecast/warning issuance). Also, an incident report window on the display section of the relevant each Org./company etc.'s system can display received incident reports and the information security history (settled and unsettled vulnerabilities and security incident history) of the host that filed the incident reports.

The center operating system 3000 of the integrated computer emergency response system analyzes and compares results of the operation of a commercial/freeware scanner during a vulnerability analysis with those stored in the database. The operating system should be able to display the intrusion detection system (IDS) logs according to significance and priority and output relevant hosts' past and present cases of receiving incident reports, such as the hosts' OS or applications.

The center operating system 3000 should manage incident histories of all company/public Org./R&D institute etc. or hosts of any pertinent each Org./company etc. and store all data relating to the incidents in files so that the data can be reflected in any internal or external report. Also, the operating system should show new vulnerabilities and related hosts and operating systems of a pertinent each Org./company etc. through a vulnerability forecast/warning window to enable comparison and management of the vulnerabilities, the hosts' incident histories and scanning results.

An ESM is a system that enables large companies, banks, insurance companies, telecommunication companies or company/public Org./R&D institute etc. having their own computer systems or centers to integratedly manage information security products (such as a firewall system, an IDS and an anti-virus solution). An ESM serves as a console combining major information security products.

The information collecting/managing section, information processing/analyzing section and operating system according to the present invention expand ESM functions and automate implementation of such functions, thereby replacing an ESM. These sections can perform a detailed data analysis in addition to known functions of an ESM. Also, they additionally comprise a superordinate program for implementing functions, such as early forecast/warning for a security incident, attack assessment, computer forensic DB generation and management, threat management, and operation of a trusted information sharing network between company/public Org./R&D institute etc., companies or organizations, thereby exchanging information about hackings or other security incidents.

The test-bed 3300 of the center operating system section 3000 provides an environment allowing a security administrator to perform a simulation of a hacking or cyber terror at a remote place. It may have an additional function of performing a test or an evaluation of a newly-adopted information security product or service.

Although not shown in the drawings, the center operating system 3000 may additionally comprise an on-line automatic education/training section for generating educational information from the results of a simulation performed at the test-bed, storing and managing the educational information and sending the educational information to an external terminal that requires education.

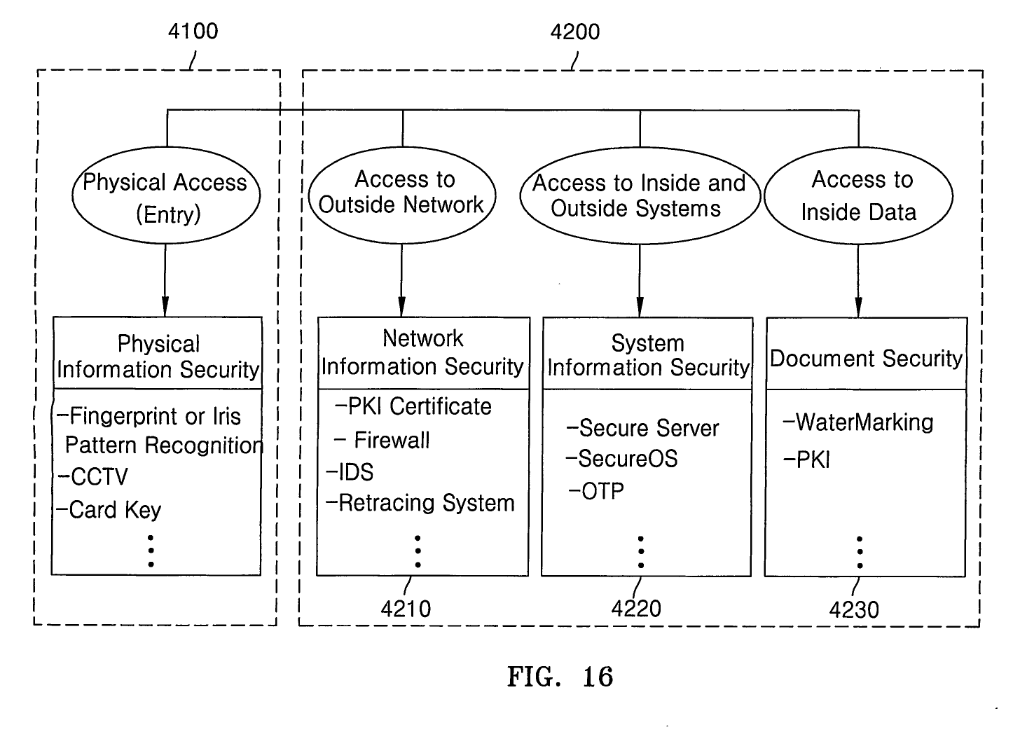

The system information security section 4000 for protecting the integrated computer emergency response system's own information may comprise: a physical information security section 4100 (see FIG. 16) including a card certification section, a password certification section, a biometrics section for recognizing fingerprints, iris patterns, palm prints or the like, a CCTV and a weight sensor; and a network/system/document security section 4200 (see FIG. 16) including a PKI certification system, an intrusion detection system, an anti-virus system, a retracing system and a watermarking system.

The CERT/ISAC/ESM to CERT/ISAC/ESM interworking section 5000 processes, analyzes and takes statistics on information to be exchanged with external systems in an encrypted standard format in order to manage the information and transmit or receive data to or from the external systems. The CERT/ISAC/ESM to CERT/ISAC/ESM interworking section 5000 controls access according to the user classes of company/public Org./R&D institute etc. and enables safe information sharing with relevant external company/public Org./R&D institute etc.

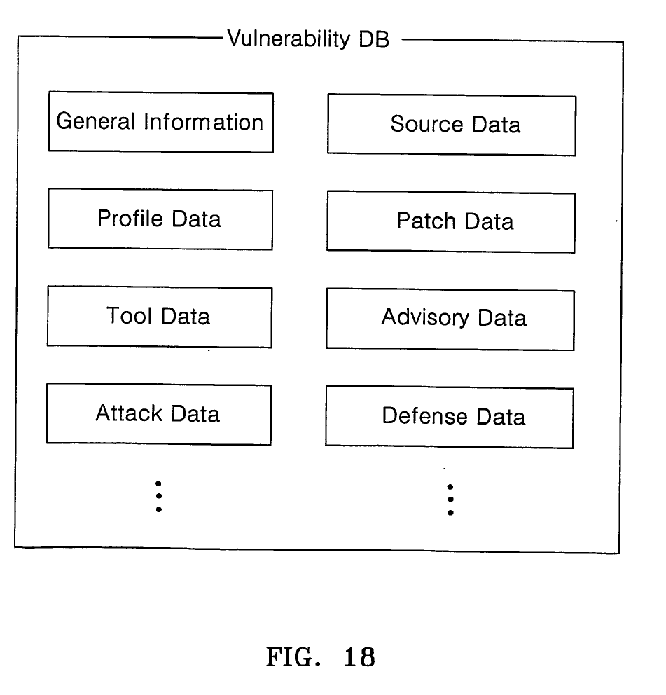

A database section 6000 may include subordinate databases that store various categories of information necessary for integrated computer emergency responses according to the present invention. For example, the database section 6000 may include, but is not limited to include: a vulnerability DB 6100 (see FIG. 18) for storing a list of various vulnerabilities of relevant systems and a vulnerability checking list; a source/processed DB 6200 for storing source data and processed data of collected security information; a reported incident DB 6300 for storing incident information inputted through the incident report collecting section 1500; a blacklist DB 6400 (see FIG. 23) for selecting habitually occurring incidents from the list of vulnerabilities and security incidents and storing the habitual incidents; a forecast/warning DB 6500 for selecting incidents about which an early forecast or alert is required from the list of vulnerabilities and security incidents and storing the selected incidents; a profile DB 6600 for storing information about relevant systems and users; an incident history DB 6700 for storing previous incidents and vulnerabilities, together with countermeasure and various log files; and a computer forensic DB 6800 (see FIG. 21) for extracting information about any events that can be considered computer crimes from the list of vulnerabilities and security incidents and storing the extracted information. If necessary, two or more of these subordinate databases can be combined into a single database.

The vulnerability DB 6100 may store patches and advisories provided by research centers, CERTs, hardware vendors and OS vendors, attack and defense methods, and various tools or utilities, as well as a vulnerability DB and a vulnerability checking list.

The source/processed DB 6200 that stores source data and processed data of collected security information can be divided into a source DB and a processed DB. The source DB should be included in a server located in a computer room independently of a network. The source DB stores source data of security information, such as damage caused by security incidents having occurred in each each Org./company etc. or company(public Org./R&D institute etc.), remedies and related records, hacking route records and incident history. When the source data is spread to government company/public Org./R&D institute etc., press centers, other company/public Org./R&D institute etc. and companies, all information related to a victim of a security incident or likely to impair the victim's credibility is converted and processed to be anonymous. The processed DB stores such processed data.

The reported incident DB 6300 may store and is not limited to store data concerning times of incidents, source IP addresses, intermediate IP addresses, target destination IP addresses, system information, incident reporter/receiver information, damages, and backup of related logs.

The blacklist DB 6400 (see FIG. 23) detects the use of an identical attack method, similar attacks, frequent or repeated attacks for a certain period of time and attacks against the same country, same ISP or same port from the vulnerability DB and the information about security incident, and selects critical incidents and vulnerabilities based on priorities of important assets, major attack methods and damages.

The forecast/warning DB 6500 sends an early forecast or alert to security administrators of nationwide systems and systems or network devices of related member companies to inform security countermeasure, patches and priorities according to asset values, attack periods and alert levels. Also, the forecast/warning DB 6500 selects necessary events and stores information about the selected events.

The profile DB 6600 stores various information about systems to be protected nationwide or enterprise-wide, such as hardwares, OS, patches, maintenance information, similar incidents and service interruption history. The profile DB 6600 also stores information about administrators who operate such systems and network devices and password management ledgers.

The incident history DB 6700 compares previous incidents, vulnerabilities, responses and various log files with the blacklist DB, forecast/warning DB and source/processed DB, and stores comprehensive history management results which are used to automatically send mail(s) and prepare a report for response results.

The computer forensic DB 6800 (see FIG. 21) interworks with the blacklist DB and the early forecast/warning section to extract information about events recognized as computer crimes from records of attacker IP addresses which were or can be origins of critical attacks. The extracted information is stored to be used as evidence later when a victim of a security attack files a criminal complaint or a civil action, seeking compensation for any financial damages or losses.

The function and structure of each element of the integrated computer emergency response system according to the present invention will be explained in more detail with reference to FIGS. 5 to 23.

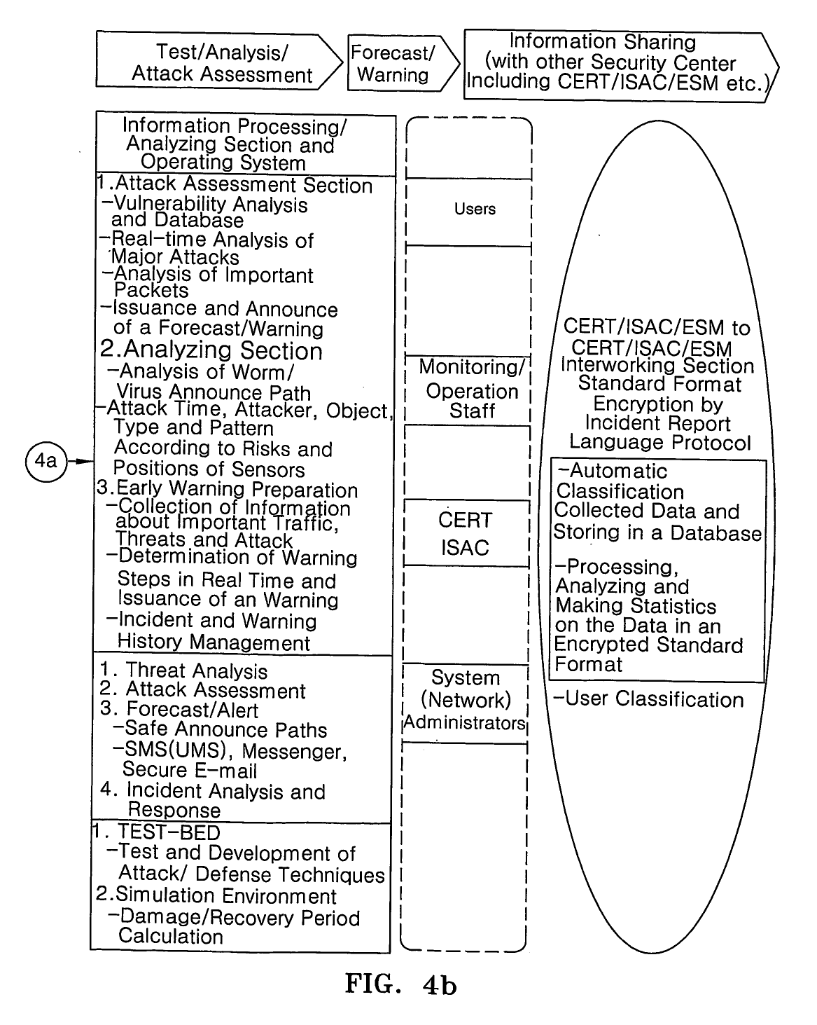

FIG. 4 shows operations of the integrated computer emergency response system according to the present invention.

The computer emergency response according to the present invention broadly comprises four procedural steps: collection of security information (information collection), test/analysis of security information and attack assessment (test/analysis/attack assessment), forecast/warning and information sharing (interworking with other company/public Org./R&D institute etc.).

In the information collecting step, information security trends, theses, reports, patches and update programs are collected from domestic or foreign information security related web sites, using a search engine such as a web robot. Enterprise security management (ESM) systems share a blacklist on attackers (attack techniques, types, frequency, countries, ISPs, ports, etc.). Domestic or foreign CERTs and ISACs cooperate to respond to security incidents (that is, receive reports for hackings, support responses, share and spread information about new hacking techniques) and issue forecasts/alerts about viruses (new viruses, worm information, vaccine updates and patches) in cooperation with providers. The CERTs and ISACs share network traffic information (abnormal traffic patterns and malicious traffic analysis) with major ISPs and log analysis/conversion information (IDS, Firewall log information and major attack type information) with information under controlled information security product for ESM.

The information collected through various channels is analyzed at the test-bed or using a predetermined analysis algorithm. The analysis data is stored and managed. Such a series of processes for information collection are performed by the information processing/analyzing section and operating system of the integrated computer emergency response system according to the present invention. The information collection consists broadly of threat analysis, test, attack assessment, alert and incident analysis/response.

The test/analysis/attack assessment step performs analyses, such as analysis of vulnerabilities to be databased, real-time analysis of major attacks, collection and analysis of important packets, and attack assessments, such as forecast/warning issuance and spread. This step makes preparations for early warning, such as collection of information about important traffic, threats and attacks, real-time response step determination and alert, and incident/alert history management, performs further analyses of worm/virus paths, times, attackers, objects, attack types, patterns, destructiveness, position of sensors and provides an analysis environment. The display section of the operating system according to the present invention outputs data concerning threat analysis, attack assessment, forecast/warning (through a safe path such as SMS (UMS), messenger or secure e-mail), incident analysis and countermeasure in separately composed windows in real time. If required for information analysis (for example, in case of new security incidents), a simulation environment is provided to predict and analyze serious incidents, service interruption or network disruption, using the test-bed.

In the forecast/warning step, the early forecast/warning section transfers a forecast or alert signal to terminals of general users, control centers, CERTs and system administrators.

The CERT/ISAC/ESM to CERT/ISAC/ESM interworking section 5000 interworks with a trusted information sharing network and related systems so that the computer emergency response system of the present invention can share necessary information about security incidents and vulnerabilities with interworking company/public Org./R&D institute etc., companies and organizations, such as individual or civil IT (information and technology) infrastructures, important computer facilities of companies, ISACs as prescribed under the Information Infrastructure Protection Act, large control centers, major government or company/public Org./R&D institute etc., telecommunication service providers and ISPs. The information sharing process is displayed in the display section (a wallscreen or a plurality of monitor sets) of the operating system. A forecast or an alert can be issued to users, monitoring/operation staff and administrators of major ISACs, CERTs and systems (network devices) based on the shared information.

Systems in a trusted information sharing network and a CyberWarroom process and analyze logs of information security products of associated ESMs, CERTs, ISACs, anti-virus product providers, ISPs, company/public Org./R&D institute etc. and companies and other information collecting channels in an encrypted standard format by incident report language protocol, and then make statistics. Through automatic classification of collected data and database management, the systems provide a systemic environment for sharing required security information with involved company/public Org./R&D institute etc., companies and centers.

FIG. 5 shows the detailed structure of the information collecting/managing section according to the present invention.

The information collecting/managing section collects information relating to system information security through all communication networks. As described above, the information collecting/managing section 1000 may include: a vulnerability DB collecting section 1100 for collecting, classifying and processing vulnerabilities officially recognized and provided by various domestic or foreign company/public Org./R&D institute etc., system hardware vendors and OS (operating system) vendors; a vulnerability scanning result collecting section 1200 for periodically scanning vulnerabilities of systems or networks and collecting the results; an information security data collecting section 1300 for collecting and storing information security data or references published by information security companies, colleges, research centers or government company/public Org./R&D institute etc. with respect to security incidents, such as hackings and cyber terror, and countermeasure against the incidents, using an automated collecting tool, such as a web robot or a search engine; a virus/worm information collecting section 1400 for collecting and storing information about computer viruses or worms using an automated collecting tool, such as a virus alert system, an agent or a search engine; an incident report collecting section 1500 for receiving security incident reports through communication means, such as telephone, facsimile, e-mail and web sites, and storing information about reported incidents in the reported incident DB 6300; a system asset information collecting section 1600 for collecting information about systems and network devices involved in the integrated computer emergency response system and asset information relating to the significance (asset values) of the systems and the network devices and storing the collected information; and an security incident collecting section 1700 for collecting and storing in real time incidents from at least one information security product of a firewall (F/W) system, an intrusion detection system (IDS), a policy management system, a anti-virus product, a PC information security system, a retracing system, a PKI certification system, a network device and a virtual private network (VPN).

Although the above elements of the information collecting/managing section are separately provided in this embodiment of the present invention, two or more of the elements can be combined if required.

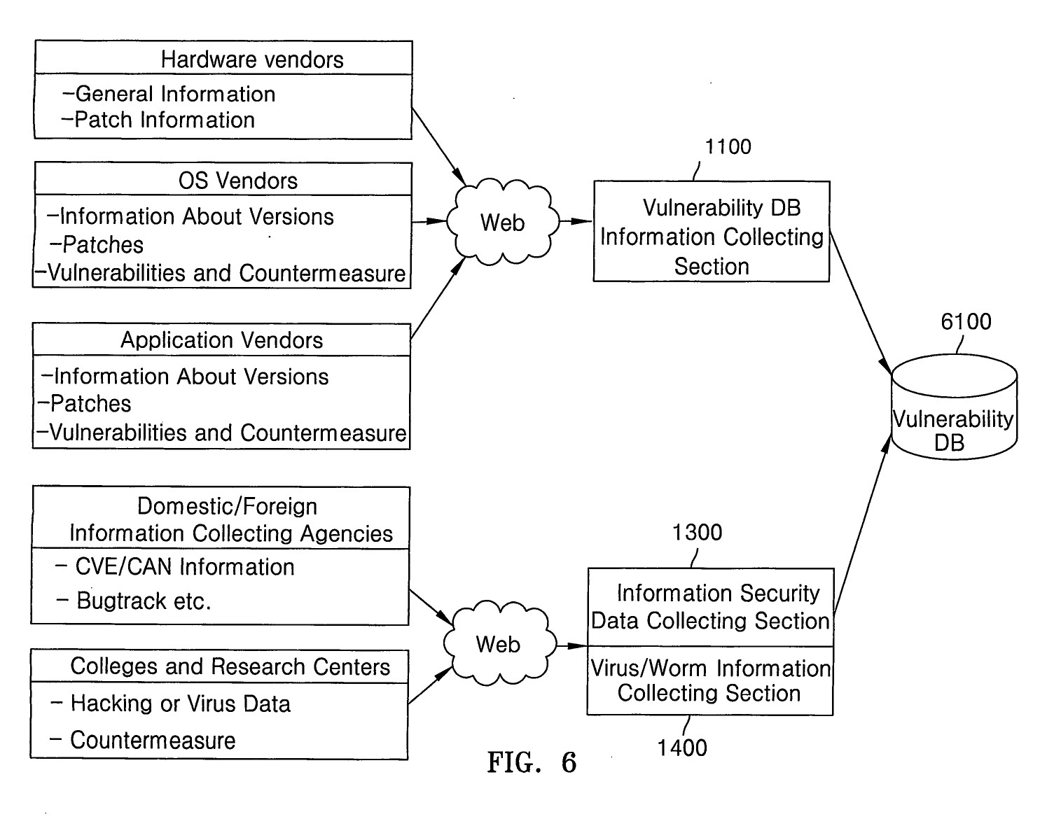

FIG. 6 is a view for explaining the functions of the vulnerability DB collecting section 1100, information security data collecting section 1300 and virus/worm information collecting section 1400 of the information collecting/managing section 1000.

The vulnerability DB collecting section 1100 receives vulnerabilities officially recognized and provided by various domestic or foreign company/public Org./R&D institute etc., system hardware vendors and OS (operating system) vendors after classifying and processing the vulnerabilities through a DB controller. Although it is preferable to automatically receive the vulnerabilities on the Web, an administrator can directly input the vulnerabilities through any other communication network.

More specifically, the vulnerability DB collecting section 1100 collects general information relating to hardwares or patch information from hardware vendors, information about OS versions, patches, vulnerabilities (problems) and countermeasure from OS vendors, and information about application program versions, patches, vulnerabilities and countermeasure from application vendors. The collected information is stored and managed in the vulnerability DB 6100.

The information security data collecting section 1300 collects and stores information security data or references published by information security companies, colleges, research centers or government company/public Org./R&D institute etc. with respect to security incidents, such as hackings and cyber terror, and countermeasure against the incidents (for example, CVE/CAN and bugtrack etc.), using an automated collecting tool, such as a web robot or a search engine. The virus/worm information collecting section 1400 collects and stores information about computer viruses or worms using an automated collecting tool, such as a virus alert system, an agent or a search engine.

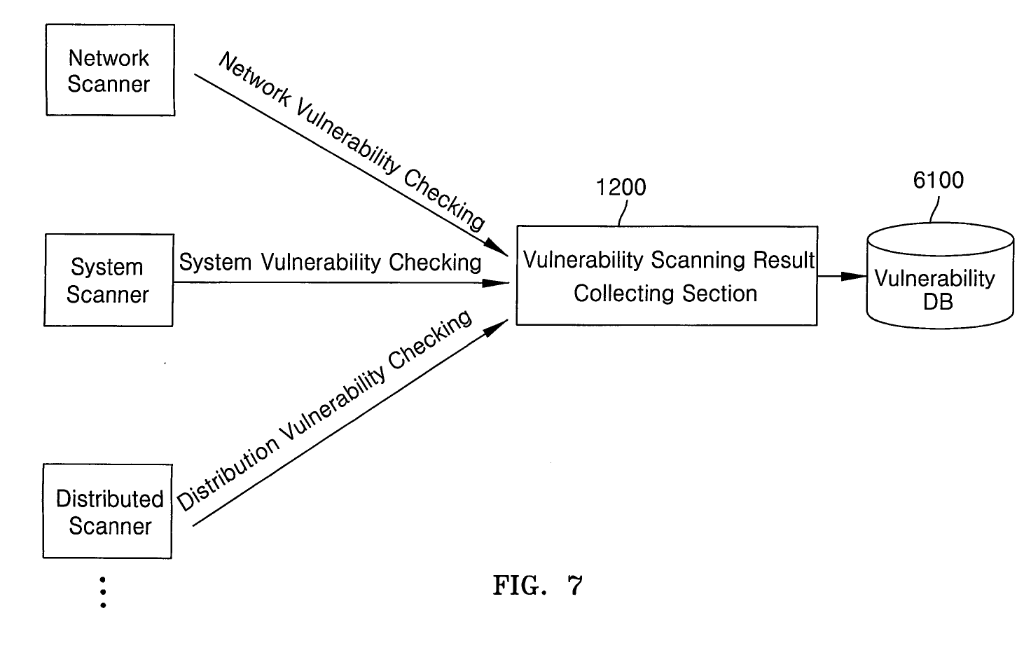

FIG. 7 shows the functions of the vulnerability scanning result collecting section 1200 of the information collecting/managing section 1000.

The vulnerability scanning result collecting section 1200 periodically scans vulnerabilities of networks or related systems and collects the scanning results. In other words, an administrator scans the vulnerabilities periodically in a particular cycle or on demand, using a network-based scanner, a system host-based scanner, a distributed scanner, a virus scanner or the like, and collects the scanning results. The collected vulnerability scanning results are stored in the vulnerability DB 6100.

The word “vulnerability” refers to any flaw or weakness in the armor of a computer DB, an OS or a network that could be exploited by a hacker to gain unauthorized access to, damage or otherwise affect the computer DB, OS or network. Vulnerabilities can be discovered or published everyday by domestic or foreign information security companies, system vendors such as IBM, MS and HP, and domestic or foreign CERTs or ISACs, or discovered by the scanning of a system itself. On the average, 10 to 100 vulnerabilities are discovered each day.

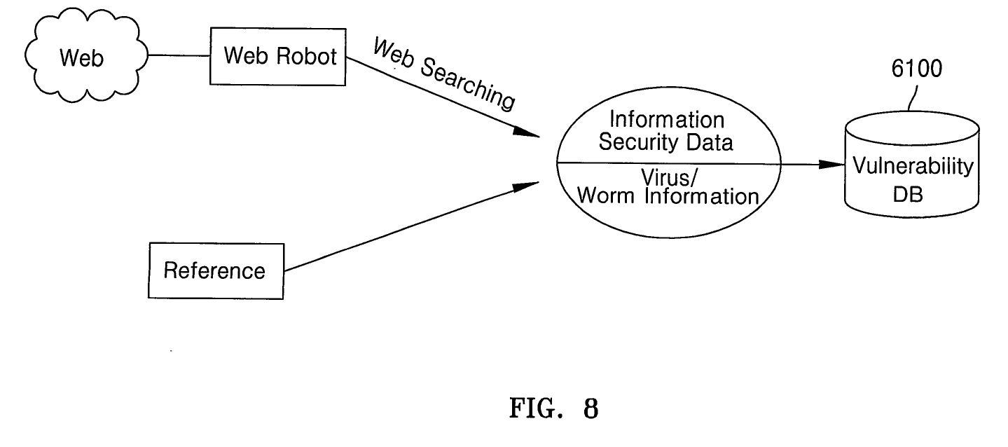

FIG. 8 is a block diagram showing the automated vulnerability collection performed by the vulnerability DB collecting section 1100, information security data collecting section 1300 and virus/worm information collecting section 1400 using a web robot.

The vulnerability DB collecting section 1100, the information security data collecting section 1300 and the virus/worm information collecting section 1400 periodically collect information about vulnerabilities (including information security data and virus/worm information) by searching related web sites, FTP, TELNET, pay or free subscription sites and e-mail groups using an automated collection tool, such as a web robot, or by referring to reference publications. The collected information is stored in the vulnerability DB. Also, the above sections automatically generate and distribute a report based on the collected data. If required, the web robot can take a report file with attachments or automatically collect information from related sites or linked sites. To collect information from multilingual web sites, the above collecting section may additionally have a function of providing web contents in Korean, English or other language, using an automatic translation site.

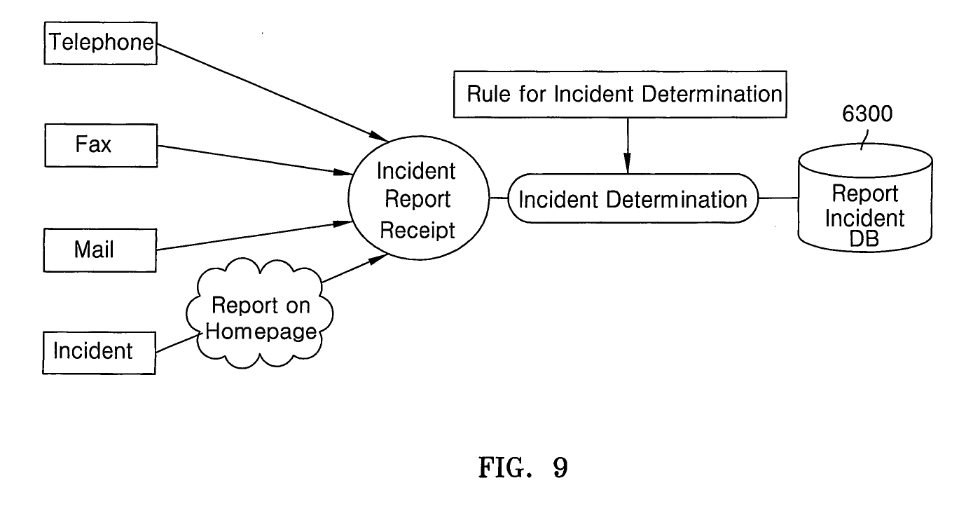

FIG. 9 is a view for explaining the functions of the incident report collecting section 1500 of the information collecting/managing section 1000.

The incident report collecting section 1500 directly receives reports for security incidents, such as hackings, viruses and other cyber terror, from security administrators of company/public Org./R&D institute etc. involved in the integrated computer emergency response system according to the present invention through the web and communication means, such as telephone, facsimile and e-mail.

The received incident reports are stored in the reported incident DB 6300, and used as basic data in an attack assessment of an incident according to predetermined rules of determination of computer emergencies (attack assessment section), in a simulation of a new incident using the test-bed (test-bed), or in calculation of damage and recovery period (asset evaluation/recovery period calculation section).

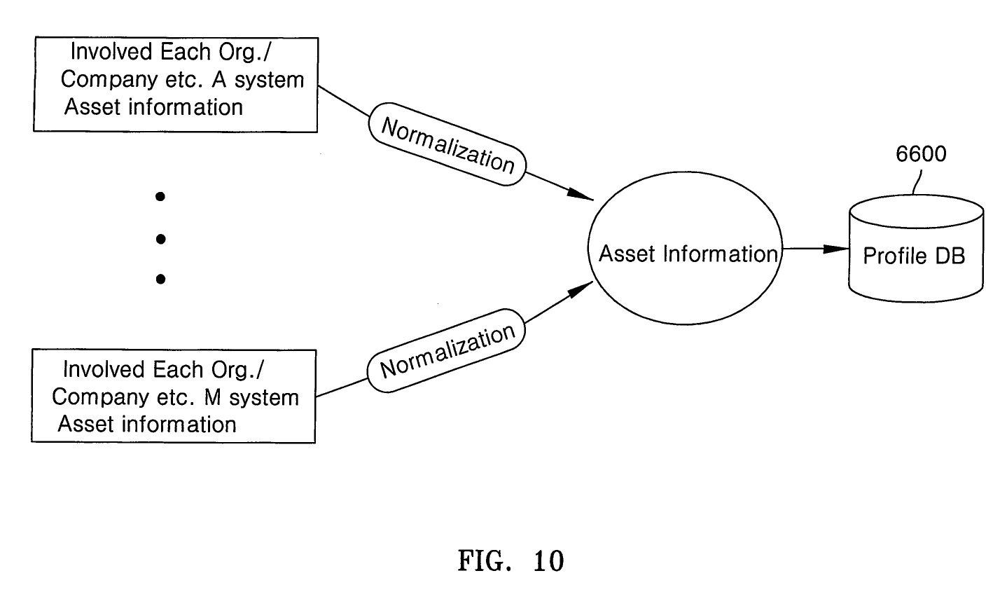

FIG. 10 is a view for explaining the functions of the asset information collecting section 1600 for collecting asset information of systems.

The asset information collecting section 1600 collects asset information of systems to be protected, including main systems and network devices of the involved company/public Org./R&D institute etc. This section normalizes collected information about the object systems and their asset values and store the information in a predetermined database, such as the profile DB. The stored information can be used in future attack assessment and calculation of damage and recovery period.

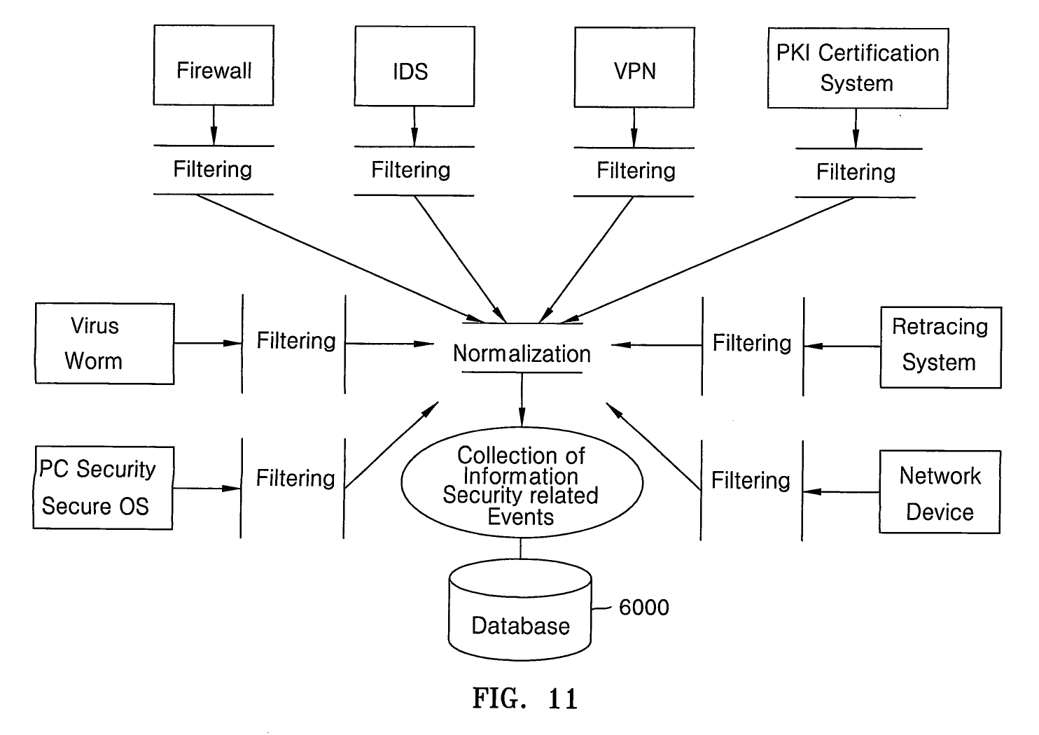

FIG. 11 is a block diagram showing the functions of the event collecting section 1700 of the information collecting/managing section 1000.

The event collecting section 1700 collects and stores in real time events relating to information security among events occurring in a firewall (F/W) system, an intrusion detection system (IDS), a virtual private network (VPN), an anti-virus system a PC information security system, a retracing system, a (PKI-based) PKI certification system, a network device and so on.

The information security products from which the events relating to information security are collected are not limited to the systems mentioned above but may include any other information security products. Collected events are stored in the database section 6000 after undergoing a predetermined filtering process.

FIG. 12 is a block diagram showing the detailed structure of the information processing/analyzing section 2000 of the integrated computer emergency response system according to the present invention.

The information processing/analyzing section 2000 includes: the dataware housing section 2100 for effectively establishing a database storing a large amount of security information collected by the information collecting/managing section 1000; and the information analyzing section 2200 for analyzing the security information by applying a data mining or knowledge-based analysis algorithm.

The security information to be analyzed includes vulnerability information (including vulnerability scanning results), virus/worm information, information security related information and incident report information. Data processed and analyzed by the information analyzing section is stored and managed in the source/processed DB.

FIG. 13 is a block diagram showing a process of establishing the dataware housing section 2100 of the information processing/analyzing section 2000.

The dataware housing section 2100 normalizes and databases collected information to be searched and processed according to various classifications.

Upon receiving security information (S2110), the dataware housing section classifies the received data (S2120). Subsequently, the dataware housing section determines whether it is required to summarize or process the data (S2130). If required, the dataware housing section will summarize the data according to search types (S2150) or add a data field (S2140) to generate a database (S2160).

Although not shown in the drawings, the information analyzing section 2200 manages analysis algorithms (addition, change or deletion in an algorithm DB) and analyzes security incidents and vulnerabilities stored in the established database (see FIG. 13), correlations with major assets collected (see FIG. 10), recognizable patterns and classifications for preventing incidents and vulnerabilities.

Of course, newly discovered vulnerabilities or security incidents are tested under the same conditions of systems to be protected, in order to find out their severity, attack level and other characteristics. Those vulnerabilities and security incidents are stored in the vulnerability DB, source/processed DB or reported incident DB according to their severity and characteristics.

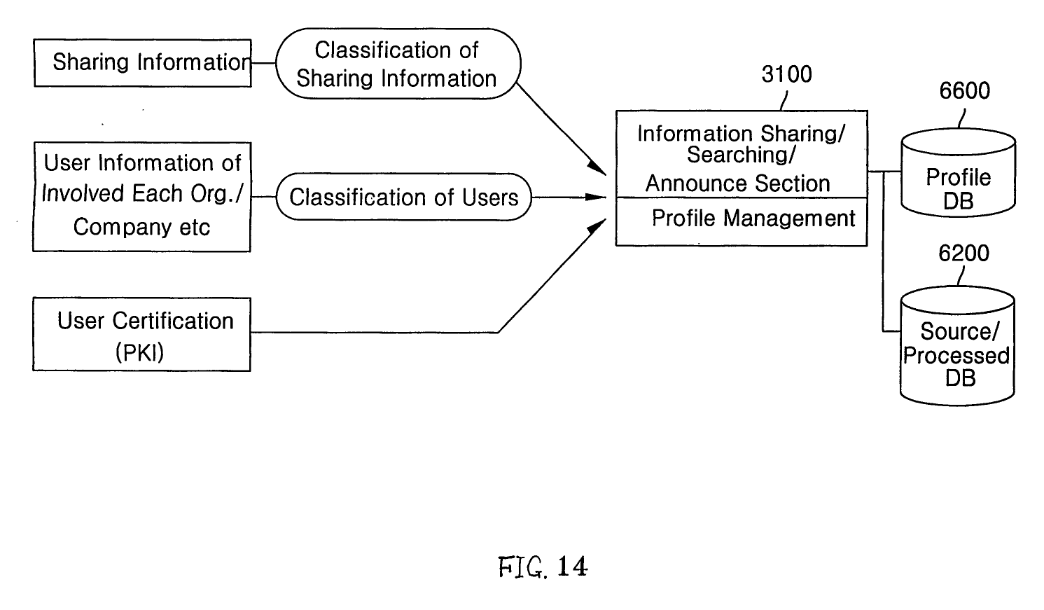

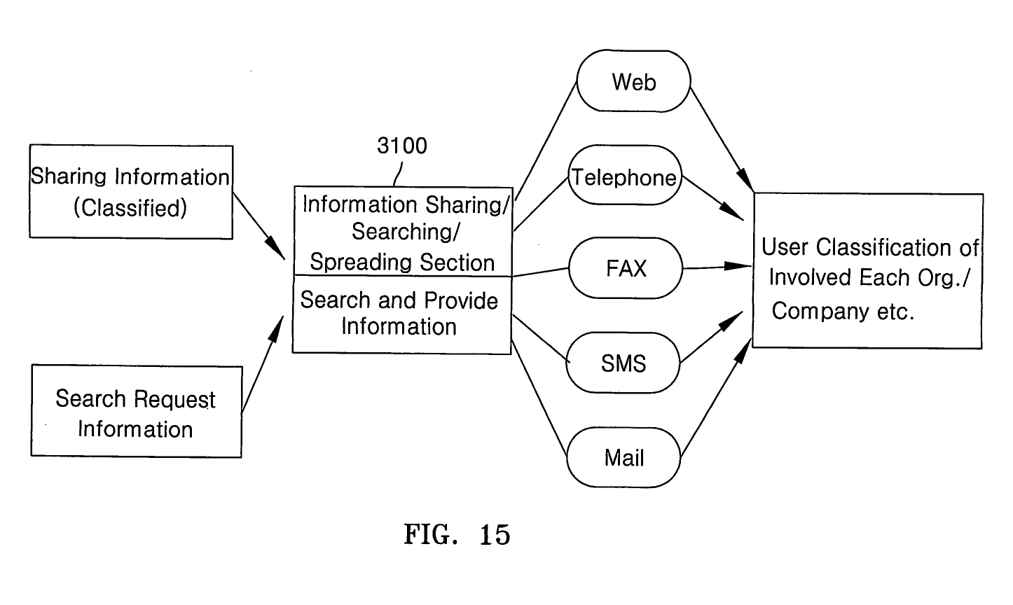

FIGS. 14 and 15 show the functions of the information sharing/searching/announce section 3100 included in the center operating system 3000. Specifically, the profile management function is shown in FIG. 14, while the search and spread functions based on the analysis results produced by the early forecast/warning section are shown in FIG. 15.

The operating system classifies information to be shared according to types or classes. Also, the operating system classifies users and company/public Org./R&D institute etc. by class to control access to information according to their classes. If necessary, the operating system may include a section for providing official certification information of users.

Such a profile management function of the information processing/analyzing section is to manage basic information necessary to respond to a security incident, i.e., information about OS versions, maintenance, incident history, patches, IDS history, etc., of object information security systems, major servers, PCs and network devices to be controlled. The profile information is stored and managed in the profile DB 6600 or the source/processed DB 6200.

FIG. 15 is a view for explaining the shared information searching and announce functions of the information-sharing/searching/announce section 3100. This section receives a user's request for information search and provides the requested information through a wire/wireless transmission medium (telephone, facsimile or text message) or the web according to the user and information classes.

FIG. 16 shows the detailed structure of the system information security section 4000 for protecting the integrated computer emergency response system's own information.

The integrated computer emergency response system established according to the present invention is a very important system. Therefore, the system information security section 4000 as shown in FIG. 16 is used as a means for protecting the system itself from an unauthorized access and preventing any system or network error.

The system information security section includes a physical information security means for physical information protection of the integrated computer emergency response system and a network/system/document security means for protecting networks, systems and documents. The physical information security means may be, but is not limited to, a card certification means, a password certification means, a biometrics means for recognizing fingerprints, iris patterns or the like, or a CCTV etc. The network/system/document security means consists of: a network security section (information security section for controlling access to an outside network) including an official PKI certificate-based PKI certification system, a firewall system, an intrusion detection system (IDS) and an incident source retracing system etc.; a document security section (information security section for controlling access to inside data), such as a watermarking encryption system for files or documents or a PKI-based key information security means etc.; and a system security section (information security section for controlling access to inside and outside systems), such as a secure server or a secure OS etc. Since the physical information security means and the network/system/document security means can be easily configured using conventional techniques, detailed explanations of the two means will be omitted herein.

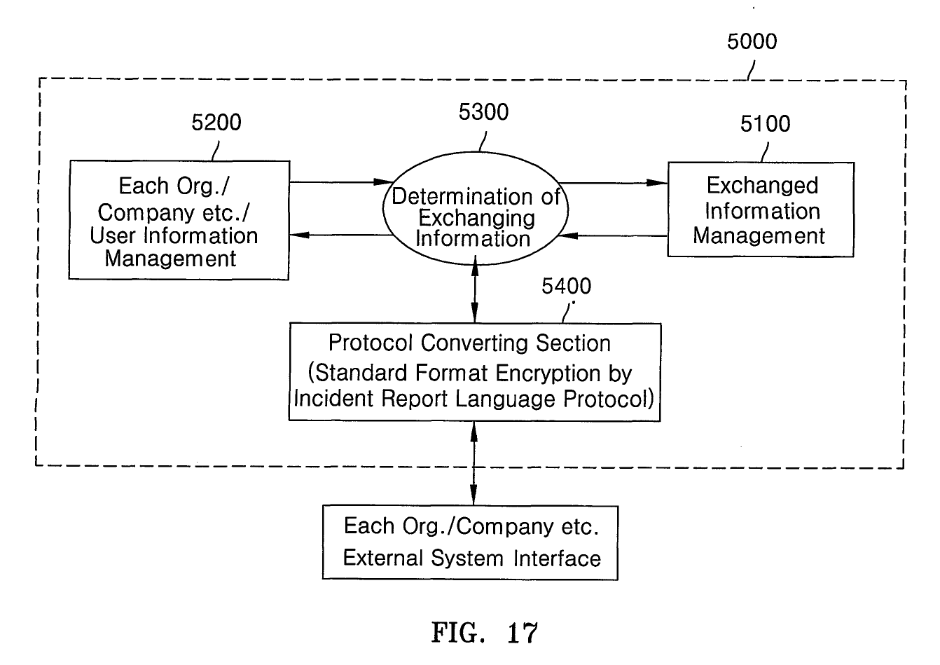

FIG. 17 is a block diagram of the CERT/ISAC/ESM to CERT/ISAC/ESM interworking section 5000 for interworking with external systems to share reliable security information.

The CERT/ISAC/ESM to CERT/ISAC/ESM interworking section 5000 interworks with related outside systems, such as a CERT system, an ISAC system, a police computer crime/cyber terror response system and an ESM for protecting important information infrastructures, in order to share necessary security information. The CERT/ISAC/ESM to CERT/ISAC/ESM interworking section 5000 consists of an each Org./company etc./user information management section, an shared information management section and an interface for performing a standard format encryption by incident report language protocol for data exchange with systems of other company/public Org./R&D institute etc.

The CERT/ISAC/ESM to CERT/ISAC/ESM interworking section 5000 classifies and manages information to be exchanged or shared. It also manages information of interworking company/public Org./R&D institute etc. When there is any information to be exchanged, the CERT/ISAC/ESM to CERT/ISAC/ESM interworking section converts the information protocol to be compatible with interfaces of the interworking company/public Org./R&D institute etc. and then transfers various information to the company/public Org./R&D institute etc. according to classified access control and user classes.

FIG. 18 shows the detailed structure of the vulnerability DB 6100 included in the database section 6000.

The vulnerability DB 6100 stores vulnerabilities that can be exploited by hackers or virus/worm writers to gain unauthorized access to, damage or otherwise attack a software of any computer DB, OS or network device, together with systemically categorized data concerning possible responses. Newly discovered vulnerabilities of systems sought to be protected are tested at the test-bed having the same environment of the systems, and stored in the vulnerability DB according to their severity and characteristics. The vulnerability DB can be divided into a general information field, a source data field, a profile data field, a patch data field, a tool data field, an advisory data field, an attack data field and a defense data field etc. However, the vulnerability DB is not limited to those fields.

Although not shown in the drawings, the source/processed DB 6200 consists of a source DB for storing detailed information about members and subscribed company/public Org./R&D institute etc. and a processed DB for storing processed data, such as incident history.

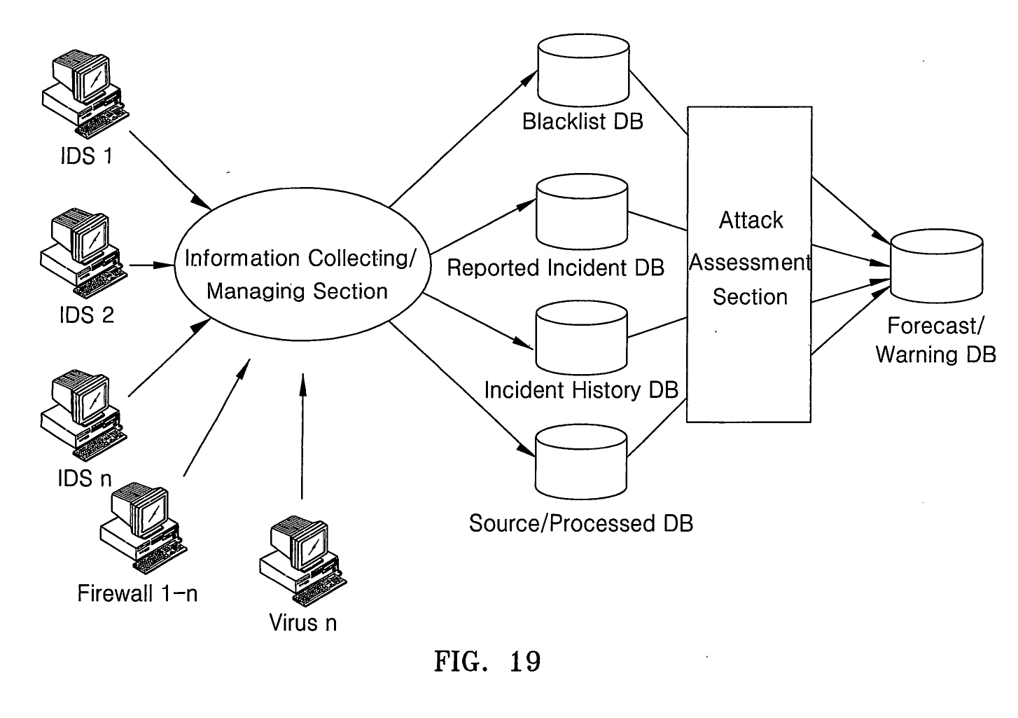

FIG. 19 is a block diagram showing information protecting and alerting mechanisms using the integrated computer emergency response system according to the present invention.

Events occurring in an information security product, for example, an intrusion detection system (IDS), are classified to be stored in the blacklist DB, IDS incident history DB or any other DB according to their severity, destination IP, source IP and ports. Based on data extracted from each DB, an attack assessment algorithm is applied to assess the level of attack and establish the early forecast/warning DB.

Various information security data obtained from other information security products, such as a firewall system, a anti-virus product server and a virtual private network (VPN), can also be used to perform an attack assessment and issues an alert. In addition, possible scenarios for incidents having occurred or likely to occur in major hosts are outlined to perform necessary simulations using the test-bed. Frequency of the same attack, same source IP and attack times detected through a data analysis are stored and managed in the database section. It is possible to generate education/training data for preventing any possible security incident based on the stored data. It is also possible to extract information useful as legally admissible evidence and store the information in the computer forensic DB.

FIG. 20 shows the function of the attack assessment section 3200 according to the present invention.

The attack assessment section 3200 included in the center operating system 3000 analyzes information provided from outside databases, such as an intrusion pattern DB, a vulnerability DB and an international DB (CVE) of an intrusion detection system etc., and classifies the information about types of attack or vulnerability, attack methods, attack steps and expected damages in categories of network exposure, system exposure, system service delay, network service delay, root authority acquisition, data release, data forgery and others etc. Subsequently, the attack assessment section re-classifies each security incident or vulnerability according to steps of attack preparation, attack and post-attack. After assessing the attack level (step), the attack assessment section classifies and stores the security incident data according to source IP addresses, internet service providers (ISP), countries, attack methods and attack periods etc. Also, different weights are given to different attack types. Any repeated attack types or regions or attacks from a blacklisted IP address are stored in the incident history DB or in the alert DB if an alert is necessary. Based on the stored information, the early forecast/warning section of the operating system issues step-by-step alerts.

FIG. 21 is a view for explaining the establishment of the computer forensic DB according to the present invention.

Data extracted from the databases used in the information protecting and alerting mechanisms as shown in FIG. 19 is normalized and classified according to attack methods, IP addresses, countries, frequencies or means. Predetermined legal guideline for determining computer emergencies are applied to each incident or vulnerability. If it is determined that any event (security incident or vulnerability) can be a legal issue or exploited in a computer crime at a later time, information about such an event is established as a database, i.e., the computer forensic DB.

If any attack has caused serious damage to a system, such as system down, the computer forensic DB can be used as evidence for any legal actions against the attacker. In other words, a victim of an attack can submit the computer forensic DB established at the time of an attack as evidence supporting a criminal or civil action against an attacker. The computer forensic DB secures and manages information about actual or suspected incidents as evidence. When an incident occurs, the computer forensic DB stores specific fields, such as date and time of the incident, detector's name and resulting or expected damage, and specific evidence, such as firewall or IDS logs, files or virus files attached to any e-mail.

The computer forensic DB may additionally have a function of storing and managing host classifications, host names, levels of exposing at risk according to host positions, asset values of the hosts, uses of the hosts, IP addresses representing the hosts, used application names and port numbers. With respect to the host operation history, it is preferable to record and manage host operation date, operator's name, operation type (OS installation, OS patch, application installation/patch, maintenance, failure checking or the like), system management department and operation beginning and finishing times.

FIG. 22 is a block diagram showing a process of asset evaluation and recovery period calculation according to the present invention.

The asset information collecting section 1600 collects asset information of systems to be protected, and normalizes significance and values of data to classify the collected information. The information is then stored in a database, such as the profile DB. When a critical incident, for example, a virus infection or cyber terror, causes service interruption, the stored asset information is used to determine recovery priorities and automatically calculate a recovery period.

The asset information can be outlined in a table consisting of items, such as use and asset value of each system or elements thereof. The asset evaluation/recovery period calculation section 3500 calculates an anticipated recovery period for each asset based on the vulnerability DB, incident history DB and profile DB. The recovery period calculation can be manually performed although automatic calculation is more preferable. The asset evaluation/recovery period calculation section calculates a recovery period in consideration of a recovery method using a backup center or system. If required, dual recovery can be proceeded for important systems.

FIG. 23 shows the establishment of the blacklist DB and the history management according to the present invention.

The blacklist DB is referred to when issuing an alert based on the history data extracted from an intrusion detection system (IDS) or the like. The blacklist DB interworks with the computer forensic DB to detect repetition of the same attack method, same IP, attacked countries, attack frequencies or means from normalized security incident data, thereby determining events to be blacklisted. The blacklisted events are stored and managed in the blacklist DB. The blacklist DB also interworks with the profile DB to provide a blacklist of events according to incident scenarios, attack levels and expected damages.

The center operating system 3000 manages all events using an integrated history manager. When a security incident or a vulnerability is discovered, the operating system determines a proper response according to the level of the incident or vulnerability (response process). To this end, the operating system should preferably sort out past responses (for example, no response, caution, telephone warning, official notification, report or indictment, and e-mail warning) as to how the past incidents or vulnerabilities were handled. Upon determining a proper response method, the operating system sends an e-mail (warning, protesting or caution urging mail) to the security incident or vulnerability source. The response results are recorded in a report.

A method for responding to a security incident using the integrated computer emergency response system according to the present invention comprises: 1) an information collecting step performed by the information collecting/managing section to collect security information about security incidents and vulnerabilities through a predetermined communication network; 2) an information processing/analyzing step performed by the information processing/analyzing section to database collected security information and analyze the databased information using a predetermined analysis algorithm; 3) an information sharing/searching/announce step of managing the processed and analyzed security information to be shared and searching for and providing the information upon request; and 4) an alerting step of sending predetermined early warning information to at least one inside or outside system if an alert is required for any incident or vulnerability. The method may further comprise the steps of: protecting the integrated computer emergency response system's own information (system's own information protecting step); and managing information which was generated by the integrated computer emergency response system and may be shared with other company/public Org./R&D institute etc., and transmitting the information to systems of other company/public Org./R&D institute etc. that require such information (interworking step).

The method may further comprise an attack assessment step of automatically assessing the attack level of each security incident or vulnerability using the attack assessment section and determining any need to issue an alert or establish a computer forensic DB or a blacklist DB according to the assessment results.

The method may further comprise: a test (simulation) step of performing a simulation of a new security incident or vulnerability under the same condition of a system to be protected and storing the simulation results; and an asset evaluation/recovery period calculation step of evaluating the asset value of a system to be protected and automatically calculating a recovery period when a security incident occurs.

While the invention has been shown and described with reference to a certain preferred embodiment thereof, it will be understood by those skilled in the art that various changes in form and details may be made therein without departing from the spirit and scope of the invention as defined by the appended claims. Therefore, the present invention is not to be unduly limited to the embodiment set forth herein, but to be defined by the appended claims, including the full scope of equivalents thereof.

### INDUSTRIAL APPLICATION

As can be seen from the foregoing, the present invention provides an integrated computer emergency response system capable of automated and systemic responses to various security incidents, such as hackings, viruses and cyber terror.

The integrated computer emergency response system automatically collects and classifies information about a wide range of threat factors (vulnerabilities), and then processes and analyzes the information in a method proper an involved organization.

It is possible to efficiently share and obtain collected information about responses to security incidents and vulnerabilities. An early warning for each security incident minimizes damages that may result from such an incident. Also, an efficient response to each security incident can be sought through an attack assessment and a test or simulation.

In addition, a computer forensic DB can be used as convincing evidence when a victim of a security incident wishes to take a legal action. The integrated computer emergency response system evaluates asset values of systems to be protected and stores the asset information which is used to automatically determine recovery priorities and calculate a recovery period when a critical incident occurs.

The integrated computer emergency response system has an interworking function for sharing reliable security information with involved outside company/public Org./R&D institute etc. and cooperating to effectively responding to security incidents.

The present invention automates the detection, analysis and response to various incidents and vulnerabilities, thereby reducing the work and cost of running expert security centers. Also, the present invention provides a condition which can solve problems associated with information collection and application, technology development, human resources and organizations.

What is claimed is:

1. An integrated computer emergency response system comprising:
an information collecting/managing section for collecting security information about a wide range of security incidents and vulnerabilities which may be a threat to systems to be protected, via nationwide or enterprise-wide information technology infrastructures, including computer systems or networks, applications and internet services, and storing source data;
an information processing/analyzing section for processing and analyzing collected security information using a predetermined analysis algorithm and storing and managing analysis results;
an operating system section including an information sharing/searching/announce unit for transferring the processed and analyzed information to at least one system to be protected or an external system and a display unit for outputting necessary security information in a predetermined form;
an information security section for protecting the integrated computer emergency response system's own information; and
a database section including a vulnerability DB for storing vulnerability information and a source/processed DB for storing source data and processed data.

2. The integrated computer emergency response system according to claim 1, further comprising an CERT/ISAC/ESM to CERT/ISAC/ESM interworking section for interworking with external systems, including ISACs, CERTs and ESMs, in order to share reliable information.

3. The integrated computer emergency response system according to claim 1, wherein said information collecting/managing section includes a vulnerability DB collecting unit for collecting, classifying and processing vulnerabilities officially recognized and provided by various domestic or foreign company system hardware vendors and OS (operating system) vendors.

4. The integrated computer emergency response system according to claim 1, wherein said information collecting/managing section includes a vulnerability scanning result collecting unit for periodically scanning vulnerabilities and collecting scanning results.

5. The integrated computer emergency response system according to claim 1, wherein said information collecting/managing section includes an information security data collecting unit for collecting and storing information security data or references published by CERTs or ISACs, colleges, research centers and government companies with respect to security incidents, including hackings, and countermeasure against the incidents, using an automated collecting tool, such as a web robot or a search engine.

6. The integrated computer emergency response system according to claim 1, wherein said information collecting/managing section includes a virus/worm information collecting unit for collecting and storing information about computer viruses or worms using an automated collecting tool, such as a virus alert system, an agent or a search engine.

7. The integrated computer emergency response system according to claim 1, wherein said information collecting/managing section includes an incident report collecting unit for receiving security incident reports through communication means, such as telephone, facsimile, e-mail and web sites, and storing information about reported incidents.

8. The integrated computer emergency response system according to claim 1, wherein said information collecting/managing section includes a system asset information collecting unit for collecting and normalizing information about systems and network devices involved in the integrated computer emergency response system and asset information relating to the significance (asset values) of the systems and the network devices and storing the collected information.

9. The integrated computer emergency response system according to claim 1, wherein said information collecting/managing section includes an event collecting unit for collecting and storing in real time events relating to information security from at least one information security product of a firewall (F/W) system, an intrusion detection system (IDS), a policy management system, a anti-virus product, a PC information security system, a retracing system, a PKI certification system, a network device and a virtual private network (VPN).

10. The integrated computer emergency response system according to claim 1, wherein said information processing/analyzing section includes:
a dataware housing unit for normalizing information collected by the information collecting/managing section in various categories and establishing a database storing information; and
an information analyzing unit for analyzing the information stored in the database established by the dataware housing section by applying a data mining or knowledge-based analysis algorithm and an analysis algorithm for analyzing security incidents and vulnerabilities, correlations with major assets, recognizable patterns and classifications for preventing incidents and vulnerabilities.

11. The integrated computer emergency response system according to claim 10, wherein said dataware housing unit receives security data, classifies the received information, determines whether the data need be summarized or processed, and if required, summarizes the data according to search types or adds a data field to generate a database.

12. The integrated computer emergency response system according to claim 1, wherein said information sharing/searching/announce section has a profile management function of classifying information to be shared according to types or classes and users/companies who will share information according to classes and a information providing function for receiving a user's request for information search and providing the requested information to the user's system.

13. The integrated computer emergency response system according to claim 2, further comprising an attack assessment section for performing attack assessments for security incidents, such as hackings or cyber terror, classifying the incidents based on past attack methods and frequencies, supplying possible attack scenarios and automatically implementing attack assessment functions, including databasing of vulnerability analysis results, real-time analysis of critical attacks, collection and analysis of important packets and issuance and spread of a forecast/warning, in a pre-defined manner.

14. The integrated computer emergency response system according to claim 13, further comprising a test-bed for supplying a possible scenario when a new security incident or vulnerability is detected and performing a simulation under the same condition of a system to be protected so that an attack level and any damage and effective response can be expected.

15. The integrated computer emergency response system according to claim 14, further comprising an early forecast/warning section for generating an alert signal to the results issued by the test-bed or attack assessment section and sending the alert signal to a system to be protected or an external system to inform of any security incident or vulnerability.

16. The integrated computer emergency response system according to claim 2, further comprising an asset evaluation/recovery period calculation section for evaluating the significance or asset value of a system to be protected and anticipating damage resulting from a possible security incident and a recovery period based on the evaluated significance of the system.

17. The integrated computer emergency response system according to claim 14, further comprising an automatic education/training section for generating educational information from the results of a simulation performed at the test-bed, storing and managing the educational information and sending the educational information to an external terminal that requires education.

18. The integrated computer emergency response system according to claim 1, wherein said information security section for protecting the integrated computer emergency response system's own information includes:
a physical information security unit including at least one of a card certification unit, a password certification unit, a biometrics unit and a CCTV; and
a network/system/document security unit including at least one of a PKI certification system, an intrusion detection system, an anti-virus system, a retracing system and a watermarking system.

19. The integrated computer emergency response system according to claim 2, wherein said CERT/ISAC/ESM to CERT/ISAC/ESM interworking section includes:
an information management unit for processing, analyzing and taking statistics on information to be exchanged with external systems in an encrypted standard format and classifying companies according to user classes; and
an interface for performing an access control (providing data according to user classes) and a protocol conversion for data exchange with external systems.

20. The integrated computer emergency response system according to claim 3, wherein said database section includes at least one of:
a vulnerability DB for storing a list of various vulnerabilities of relevant systems and a vulnerability checking list;
a source/processed DB for storing source data and processed data of collected security information;
a reported incident DB for storing incident information inputted through the incident report collecting section;
a blacklist DB for selecting habitually occurring incidents from the list of vulnerabilities and security incidents and storing the habitual incidents;
an alert DB for selecting incidents about which an early forecast or alert is required from the list of vulnerabilities and security incidents and storing the selected incidents;
a profile DB for storing information about relevant systems and users; and
an incident history DB for storing previous incidents and vulnerabilities, together with countermeasure against such incidents and vulnerabilities and various log files.

21. The integrated computer emergency response system according to claim 3 or 20, wherein said database section includes a computer forensic DB for extracting information about events recognized as computer crimes from records of attacker IP addresses which were or can be origins of critical attacks and storing the extracted information for use as evidence later when a victim of a security attack files a criminal complaint or a civil action, seeking compensation for any financial damages or losses.

22. A method for responding to a security incident by using an integrated computer emergency response system, which comprises:
an information collecting step performed by an information collecting/managing section to collect security information about security incidents and vulnerabilities through a predetermined communication network;
an information processing/analyzing step performed by an information processing/analyzing section to database collected security information and analyze the databased information using a predetermined analysis algorithm;
an information sharing/searching/announce step of managing processed and analyzed security information to be shared and searching for and providing the information upon request; and
an alerting step of sending predetermined early warning information to at least one of any inside and outside systems if an alert is required for any incident or vulnerability.

23. The method according to claim 22, further comprising a step of automatically protecting the integrated computer emergency response system's own information by using a predetermined information security section.

24. The method according to claim 22, further comprising a step of managing information which was generated by the integrated computer emergency response system and may be shared with other companies, and transmitting the information to systems of other companies that require such information.

25. The method according to claim 22, further comprising an attack assessment step of automatically assessing the attack level of each security incident or vulnerability using the attack assessment section and determining any need to issue an alert or establish a computer forensic DB or a blacklist DB according to the assessment results.

26. The method according to claim 22, further comprising a test (simulation) step of performing a simulation of a new security incident or vulnerability under the same condition of a system to be protected and storing simulation results.

27. The method according to claim 22, further comprising an asset evaluation/recovery period calculation step of evaluating the asset value of a system to be protected based on a pre-inputted guideline and automatically calculating at least one of a recovery period and damage when a security incident occurs.
